(19) United States
(12) Patent Application Publication
(10) Pub. No.: US 2026/0031934 A1
(43) Pub. Date: Jan. 29, 2026

(54) MODEM CHIP CAPABLE OF PERFORMING CYCLIC REDUNDANCY CHECK USING INTERNAL MEMORY AND SYSTEM ON CHIP INCLUDING THE MODEM CHIP

(71) Applicant: SAMSUNG ELECTRONICS CO., LTD., Suwon-si (KR)

(72) Inventors: Jimin BAE, Suwon-si (KR); Gangmi GIL, Suwon-si (KR); Hyungu KANG, Suwon-si (KR)

(73) Assignee: SAMSUNG ELECTRONICS CO., LTD., Suwon-si (KR)

(21) Appl. No.: 19/030,230

(22) Filed: Jan. 17, 2025

(30) Foreign Application Priority Data
Jul. 23, 2024 (KR) 10-2024-0097519

(51) Int. Cl. H04L 1/1812; H04L 1/00

(52) U.S. Cl. CPC H04L 1/1816; H04L 1/0057

(57) ABSTRACT

A modem chip receives a codeword including a transport block composed of a plurality of code blocks, and includes a hybrid automatic repeat request (HARQ) processing circuit configured to perform a HARQ-based processing operation with respect to the codeword, and an internal memory configured to store data generated by the HARQ processing circuit. The HARQ processing circuit includes a code block processing circuit configured to decode the plurality of code blocks in units of code blocks and perform a first cyclic redundancy check on each of the decoded plurality of code blocks, and a codeword processing circuit configured to perform a second cyclic redundancy check on a decoded transport block.

### CROSS-REFERENCE TO RELATED APPLICATION

This application is based on and claims priority under 35 U.S.C. § 119 to Korean Patent Application No. 10-2024-0097519, filed on Jul. 23, 2024, in the Korean Intellectual Property Office, the disclosure of which is incorporated by reference herein in its entirety.

### BACKGROUND

The present disclosure relates to a modem chip capable of decoding a codeword and performing a cyclic redundancy check (CRC) on the decoded codeword and a system-on-chip including the modem chip.

In a communication system, a transmission device may transmit a codeword including a transport block composed of code blocks to a reception device. The codeword may include CRC bits for a CRC on each code block (hereinafter, referred to as a first CRC) and transport block cyclic redundancy check (TBCRC) bits for a CRC with respect to a transport block (hereinafter, referred to as a second CRC).

A modem of the reception device may determine whether a received codeword has been successfully decoded by decoding the received codeword in units of code blocks, performing a first CRC for each decoded code block, and performing a second CRC with respect to a decoded transport block.

When a failed code block is detected in the first CRC check among the decoded code blocks, the modem may request the transmission device to retransmit a corresponding code block in units of code block groups and decoded code blocks that passed the first CRC may be stored in an external memory. Thereafter, the modem may read the decoded code blocks from the external memory, generate a decoded transport block by concatenating a decoding result of the retransmitted code block with the read-out decoded code blocks, and perform a second CRC on the decoded transport block.

Because the external memory is also used by a processor other than the modem of the reception device, a bus connecting the external memory to each of the modem and the processor may be switched to a busy state by the processor, and thus, communication through the bus between the modem and the external memory may become temporarily difficult. In addition, as data size of the decoded code blocks stored in the external memory gradually increases with the advancement of communication technology, access to the external memory of the modem for a second CRC may increase a load on the bus and the external memory. Accordingly, a modem's second CRC on a decoded transport block may not completed within a preset time, resulting in degradation in the modem's performance.

### SUMMARY

Embodiments provide a modem chip capable of performing a second cyclic redundancy check (CRC) based on remainders of target blocks corresponding to code blocks of a codeword and storing intermediate data generated in the second CRC in an internal memory and a system on chip including the modem chip.

According to an aspect of the disclosure, there is provided a modem chip configured to receive a codeword including a transport block including a plurality of code blocks, the modem chip including: a hybrid automatic repeat request (HARQ) processing circuit configured to perform a HARQ-based processing operation with respect to the codeword; and an internal memory configured to store data generated by the HARQ processing circuit, wherein the HARQ processing circuit includes: a code block processing circuit configured to: decode the plurality of code blocks in units of code blocks to obtain a plurality of decoded code blocks, and perform a first cyclic redundancy check on each decoded code block of the plurality of decoded code blocks; and a codeword processing circuit configured to perform a second cyclic redundancy check on a decoded transport block, and the second cyclic redundancy check includes: a first operation of sequentially generating, based on a modular arithmetic using a polynomial for the second cyclic redundancy check, target blocks corresponding to decoded code blocks, and a second operation of determining, based on a final remainder corresponding to a last target block among the target blocks, whether the second cyclic redundancy check has passed.

According to an aspect of the disclosure, there is provided a modem chip configured to communication with an external memory via a bus, the modem chip including: a hybrid automatic repeat request (HARQ) processing circuit configured to perform a HARQ-based processing operation with respect to a codeword including a transport block composed of a plurality of code blocks; and an internal memory configured to assist an operation of the HARQ processing circuit, wherein the HARQ processing circuit includes: a code block processing circuit configured to store, in the external memory, decoded second code blocks, excluding a decoded first code block that has failed a first cyclic redundancy check, among the decoded code blocks; and a codeword processing circuit configured to store intermediate data generated from a second cyclic redundancy check in the internal memory, based on the second cyclic redundancy check being temporarily suspended due to a failure of the decoded first code block in the first cyclic redundancy check, while performing a second cyclic redundancy check on a decoded transport block based on target blocks corresponding to the decoded code blocks.

According to an aspect of the disclosure, there is provided a system on chip including: a modem including an internal memory, the modem configured to support a hybrid automatic repeat request (HARQ) function; a processor configured to perform a certain data processing operation; and a memory configured to be shared by the modem and by the processor, wherein the modem is further configured to: store, in the memory, a decoded first code block that passed a first cyclic redundancy check among the decoded code blocks, and store, in the internal memory, intermediate data generated during a second cyclic redundancy check with respect to a transport block corresponding to the decoded code blocks.

### BRIEF DESCRIPTION OF THE DRAWINGS

Embodiments will be more clearly understood from the following detailed description taken in conjunction with the accompanying drawings, in which:

FIG. 1 is a schematic block diagram of a system on chip according to an embodiment;

FIG. 2 is a diagram for explaining a codeword according to an embodiment;

FIG. 3 is a flowchart of an operation method of a hybrid automatic repeat request (HARQ) processing circuit according to an embodiment;

FIG. 4 is a block diagram of a modem according to an embodiment;

FIGS. 5A through 5C are diagrams for explaining a second cyclic redundancy check (CRC) performed by a modem chip according to an embodiment;

FIGS. 6A through 6C are diagrams for explaining a second CRC performed by a modem chip in detail, according to an embodiment;

FIGS. 7A through 7C are diagrams for explaining a second CRC performed by a modem chip in detail, according to an embodiment;

FIGS. 8A and 8B are diagrams for explaining a second CRC performed by a modem chip, according to an embodiment;

FIGS. 9A and 9B are diagrams for explaining a second CRC performed by a modem chip in detail, according to an embodiment;

FIGS. 10A and 10B are diagrams for explaining a second CRC performed by a modem chip in detail, according to an embodiment;

FIG. 11 is a diagram for explaining a relationship between a section in which a first CRC is performed and a section in which a second CRC is performed, according to an embodiment;

FIGS. 12A and 12B are diagrams for explaining an implementation example of an internal memory according to an embodiment;

FIGS. 13A and 13B are diagrams for explaining an implementation example of an internal memory according to an embodiment;

FIG. 14 is a block diagram for explaining an implementation example of an internal memory according to an embodiment;

FIG. 15 is a block diagram of a CB concatenation and transport block cyclic redundancy check (TBCRC) circuit according to an embodiment;

FIG. 16 is a flowchart of an operation method of a HARQ processing circuit according to an embodiment;

FIG. 17 is a block diagram of an electronic device according to an embodiment; and

FIG. 18 is a view illustrating communication apparatuses configured to perform a second CRC according to an embodiment.

### DETAILED DESCRIPTION OF THE EMBODIMENTS

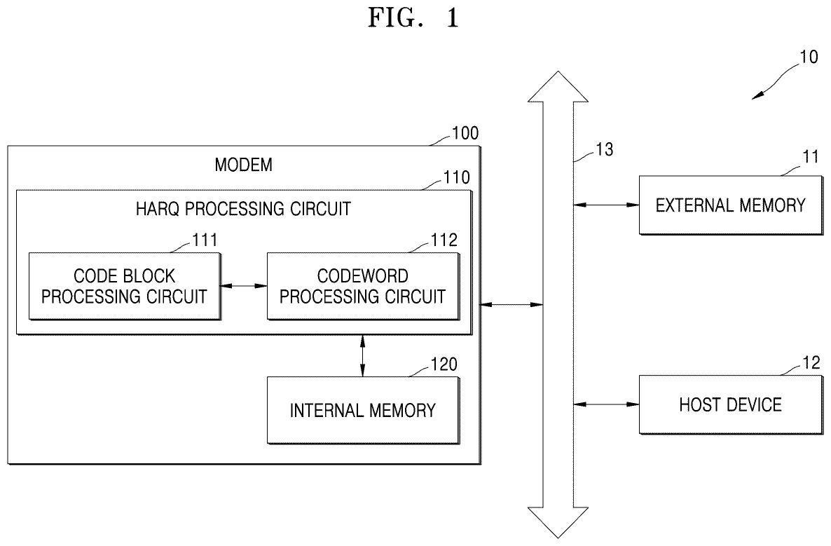

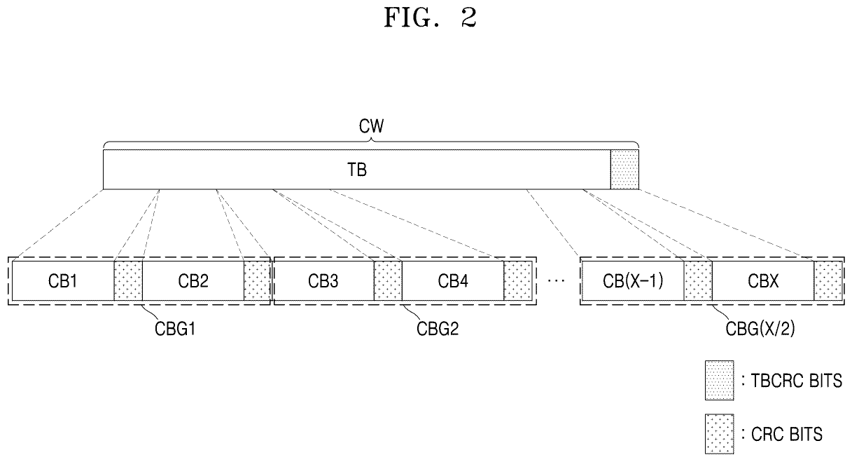

FIG. 1 is a schematic block diagram of a system on chip 10 according to an embodiment, and FIG. 2 is a drawing for explaining a codeword CW.

Referring to FIG. 1, the system on chip 10 may include a modem 100, an external memory 11, a host device 12, and a bus 13. The modem 100 may be implemented as a separate semiconductor chip and thus may correspond to a modem chip included in the system on chip 10. In this specification, the modem 100 may be referred to as a modem chip. The modem 100, which is a processor configured to process a baseband signal, may also be referred to as a baseband processor. The system on chip 10 may be included in various devices that perform communication, and the system on chip 10 may further include a radio frequency (RF) chip. The RF chip may convert a high-frequency signal received through an antenna module into a baseband signal and provide the baseband signal to the modem 100.

According to an embodiment, the external memory 11 is a memory that may be accessed by the modem 100 and the host device 12 via the bus 13 and may be shared by the modem 100 and the host device 12. Herein, the external memory 11 and the internal memory 120 are defined based on the modem 100, and thus, the external memory 11 may be a memory physically disposed away from the modem 100 and the internal memory 120 may be a memory disposed inside the modem 100. For example, the external memory 11 may be realized as a volatile memory. In detail, the external memory 11 may be implemented as a dynamic random-access memory (DRAM), a synchronous DRAM (SDRAM), a double data rate (DDR) SDRAM, etc. According to some embodiments, the external memory 11 may also be realized as a nonvolatile memory.

According to an embodiment, the host device 12 may be a device accessible to the external memory 11 via the bus 13. For example, the host device 12 may be any of various types of devices that process data, such as, a central processing unit (CPU), a graphics processing unit (GPU), and a neural processing unit (NPU).

According to an embodiment, the modem 100 may include a hybrid automatic repeat request (HARQ) processing circuit 110 and the internal memory 120. In various mobile communication standards such as long-term evolution (LTE) or new radio (NR), an HARQ function is defined. The HARQ processing circuit 110 may support a HARQ function according to the mobile communication standard. The HARQ processing circuit 110 may be implemented as hardware for performing embodiments to be described below, or may be implemented as software that is executed by a processor within the modem 100. According to some embodiments, the HARQ processing circuit 110 may also be implemented as a software/hardware combination. For example, the internal memory 120 may be realized as a volatile memory that is dedicated to the modem 100. In detail, the internal memory 120 may be realized as a cache memory such as a static RAM (SRAM). According to some embodiments, the internal memory 120 may be implemented as a DRAM, an SDRAM, a DDR SDRAM, or the like. For example, the capacity of the internal memory 120 may be less than the capacity of the external memory 11. For example, a maximum size of data stored as a result of performing a second cyclic redundancy check (CRC) in the internal memory 120 may be less than a maximum size of data stored as a result of performing a first CRC in the external memory 11.

According to an embodiment, the internal memory 120 may be implemented based on at least one of the number of HARQ processes supported by the modem 100 and the number of component carriers supported by the modem 100.

According to an embodiment, the HARQ processing circuit 110 may include a code block processing circuit 111 and a codeword processing circuit 112. The code block processing circuit 111 may perform a processing operation in units of code blocks with respect to a received codeword, and the codeword processing circuit 112 may perform a processing operation in units of codewords with respect to a result of processing a codeword of the code block processing circuit 111. Herein, an operation of the HARQ processing circuit 110 may be understood as an operation of the modem 100.

FIG. 2 will now be described to explain the configuration of the codeword.

The codeword CW includes a transport block TB, and may include transport block cyclic redundancy check (TBCRC) bits arranged at the end of the transport block TB in order to determine whether the transport block TB has been successfully decoded on a reception side (or a reception device). Additionally, the codeword CW may include first, second, third, fourth, . . . , (X−1)th, and X-th (where X is an integer greater than or equal to 2) code blocks CB1, CB2, CB3, CB4, . . . , CB(X−1), and CBX. Each of the first through X-th code blocks CB1 through CBX may include CRC bits arranged at the end of the code block to determine whether a corresponding code block has been successfully decoded on the reception side (or the reception device). In an NR network, as the size of the codeword CW increases, an operation according to an HARQ function in communication based on NR networks may support retransmission in units of code block groups. For example, the first through X-th code blocks CB1 through CBX may be classified into a code block group. In detail, a first code block group CBG1 may include the first and second code blocks CB1 and CB2, a second code block group CBG2 may include the third and fourth code blocks CB3 and CB4, and an (X/2)-th code block group CBG (X/2) may include the (X−1)-th and X-th code blocks CB(X−1) and CBX. When the first CRC on the first code block CB1 has failed, the first code block group CBG1 including the first code block CB1 may be retransmitted.

Although embodiments are described on the premise of a communication operation based on an NR network, they are merely exemplary, and embodiments are not limited thereto. Embodiments are applicable to various types of networks that support the HARQ function. In addition, the structure of the codeword CW of FIG. 2 is schematically described for convenience of description, and embodiments are not limited by the structure of the codeword CW.

Referring back to FIG. 1, the code block processing circuit 111 may decode code blocks included in the received codeword, in units of code blocks, and may perform a first CRC on each of the decoded code blocks. For example, the code block processing circuit 111 may decode each of the first through X-th code blocks CB1 through CBX of FIG. 2, and perform a first CRC by performing a modular arithmetic on each of the decoded first through X-th code blocks CB1 through CBX of FIG. 2 by using a first polynomial for the first CRC. The code block processing circuit 111 may determine that a code block of which a remainder obtained by the modular arithmetic is ‘0’ among the decoded first through X-th code blocks CB1 through CBX of FIG. 2 has passed the first CRC, and may determine that a code block of which a remainder is not ‘0’ has failed the first CRC. The modem 100 may request the transmission side (or the transmission device) to retransmit a code block group including the code block that has failed the first CRC. At this time, the code block processing circuit 111 may store, in the external memory 11, decoded code blocks that have passed the first CRC.

According to an embodiment, the codeword processing circuit 112 may perform a second CRC on a decoded transport block. For example, the codeword processing circuit 112 may sequentially generate target blocks corresponding to the decoded code blocks, based on a modular arithmetic using a second polynomial for a second CRC, and may determine whether the second CRC has been passed, based on a final remainder corresponding to a last target block among the target blocks. Herein, the modular arithmetic may also be referred to as a remainder arithmetic. According to an embodiment, in the second CRC by the codeword processing circuit 112, a decoded transport block may be generated by concatenating decoded code blocks with each other, and remainders obtained by dividing the generated decoded transport block by the second polynomial which may not be directly utilized, but remainders obtained by sequentially dividing target blocks corresponding to the decoded code blocks by a second polynomial may be indirectly utilized. Herein, a method of the second CRC by the codeword processing circuit 112 may be defined as a method based on the linear characteristics of the remainders corresponding to the target blocks. This will be described in detail later.

According to an embodiment, the second CRC by the codeword processing circuit 112 may be temporarily suspended until a code block that has failed the first CRC is retransmitted and processed by the code block processing circuit 111, and, at this time, the codeword processing circuit 112 may store, in the internal memory 120, intermediate data generated in the second CRC before the second CRC is suspended. According to an embodiment, the size of the intermediate data may be based on a second polynomial used in a modular arithmetic in the second CRC. According to an embodiment, the codeword processing circuit 112 may read intermediate data from the internal memory 120 in response to the retransmitted code block having passed the first CRC performed by the code block processing circuit 111, and may resume the second CRC, based on the read-out intermediate data.

In detail, the codeword processing circuit 112 may generate a first target block corresponding to the first code block CB1 of FIG. 2 decoded by the code block processing circuit 111, and may divide the first target block by a second polynomial to generate a first remainder. For example, the first target block may include the decoded first code block CB1 of FIG. 2 and zero bits. The codeword processing circuit 112 may generate a second target block corresponding to the second code block CB2 of FIG. 2 decoded by the code block processing circuit 111, and may divide the second target block by a second polynomial to generate a second remainder. For example, the second target block may include the decoded second code block CB2 of FIG. 2, the first remainder, and the zero bits. Then, the codeword processing circuit 112 may generate a third target block corresponding to the third code block CB3 of FIG. 2 decoded by the code block processing circuit 111, and may divide the third target block by a second polynomial to generate a third remainder. In this manner, the codeword processing circuit 112 may sequentially generate fourth through X-th target blocks corresponding to the fourth through X-th code blocks CB4 through CBX of FIG. 2. The X-th target block corresponds to the X-th code block CBX of FIG. 2 disposed at the very last position in the codeword CW of FIG. 2, and thus may be referred to as a last target block, and a remainder obtained by dividing the X-th target block by the second polynomial may be referred to as a final remainder. According to an embodiment, the first through X-th target blocks may have the same data length to be suitable for a modular arithmetic, and, to this end, the first through X-th target blocks may include different patterns of zero bits. When the fourth code block CB4 of FIG. 2 has failed the first CRC and the remaining code blocks CB1 through CB3 and CB5 through CBX of FIG. 2 have passed the first CRC, the codeword processing circuit 112 may store, in the internal memory 120, intermediate data including valid remainders not associated with the fourth code block CB4 of FIG. 2 among first through X-th remainders corresponding to the first through X-th target blocks. Thereafter, when the retransmitted fourth code block (CB4) is decoded and has passed the first CRC in the code block processing circuit 111, the codeword processing circuit 112 may read the intermediate data from the internal memory 120, and may update a final remainder corresponding to the X-th target block, based on a target block corresponding to the retransmitted decoded fourth code block (CB4) and the read-out intermediate data. When the updated final remainder is ‘0’, the codeword processing circuit 112 may determine that the decoded transport block has passed the second CRC.

According to an embodiment, when all of the decoded code blocks have passed the first CRC and have passed the second CRC using target blocks corresponding to the decoded code blocks, the codeword processing circuit 112 may concatenate the decoded code blocks to generate the decoded transport block (or a decoded codeword). The codeword processing circuit 112 may provide the generated decoded transport block to an upper layer. The codeword processing circuit 112 may read at least one of the decoded code blocks from the external memory 11 via the bus 13 to generate the decoded transport block.

In summary, when there is a code block in the codeword that requires retransmission, the code block processing circuit 111 may back up, in the external memory 11, decoded code blocks that have passed the first CRC. The codeword processing circuit 112 may sequentially receive decoded code blocks from the code block processing circuit 111, and may sequentially generate target blocks corresponding to the decoded code blocks and may use the generated target blocks to perform a second CRC on the decoded transport block. The codeword processing circuit 112 may back up intermediate data generated in the second CRC, in the internal memory 120. When it is determined that a result of the second CRC has passed, the codeword processing circuit 112 may read the decoded code blocks from the external memory 11 via the bus 13 to generate the decoded transport block. Through this operation, the number of accesses to the external memory 11 through the bus 13 of the modem 100 may be minimized, and a burden on the bus 13 and the external memory 11 also used by the host device 12 may be reduced.

The codeword processing circuit 112 does not wait until all processing operations (e.g., operations including decoding and a first CRC) for all code blocks in the code block processing circuit 111 are completed, and, whenever a processing operation for one code block is completed, the codeword processing circuit 112 may receive the processed code block from the code block processing circuit 111 and perform a second CRC. For example, the codeword processing circuit 112 may generate a target block by using a code block received from the code block processing circuit 111, and may perform a modular arithmetic on the target block to perform a second CRC. That is, a section in which a first CRC is performed by a code block processing circuit may partially overlap with a section in which a second CRC is performed by a code word processing circuit.

The modem 100 according to an embodiment may perform a second CRC on a decoded transport block by using target blocks corresponding to the decoded code blocks, and may store intermediate data generated in the second CRC in the internal memory 120 to thereby minimize access to the external memory 11 shared by the host device 12, thereby reducing the burden on the external memory 11 and the bus 13.

The modem 100 according to an embodiment may perform a rapid and effective processing operation independent of an operating state of the host device 12 by using the internal memory 120, which is dedicated to the modem 100, in a second CRC.

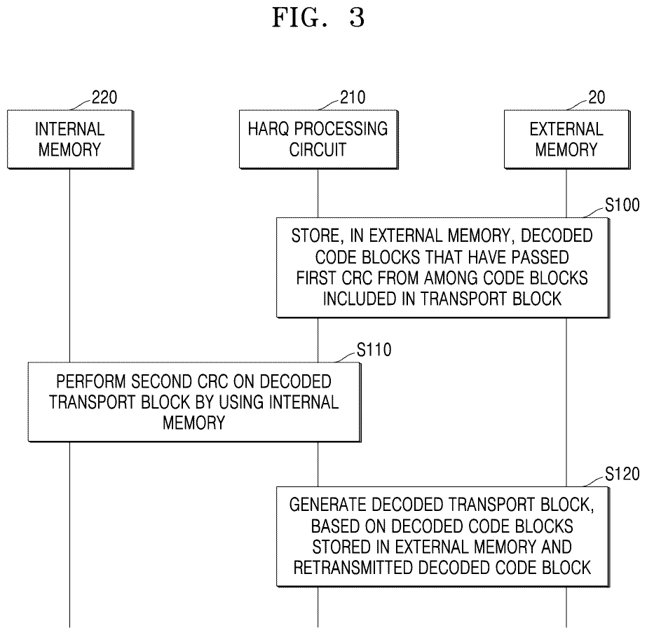

FIG. 3 is a flowchart of an operation method of an HARQ processing circuit 210 according to an embodiment. The HARQ processing circuit 210 is a component included in a modem chip, together with an internal memory 220, and an operation of the HARQ processing circuit 210 may be understood as an operation of the modem chip.

Referring to FIG. 3, in operation S100, the HARQ processing circuit 210 may store, in an external memory 20, decoded code blocks that have passed a first CRC from among code blocks included in a transport block in the external memory 20. For example, the HARQ processing circuit 210 may decode the code blocks included in a transport block of a received codeword, and may perform a first CRC on the decoded code blocks. At this time, the HARQ processing circuit 210 may identify a code block that has failed the first CRC from among the decoded code blocks, and may request a transmission device to retransmit a code block group including the identified code block. In FIG. 3, it is described assuming that there is only one code block that has failed the first CRC. However, this is only an example, events are not limited thereto. For example, the HARQ processing circuit 210 may transmit, to the transmission device, an ACK message for code block groups including decoded code blocks that have passed the first CRC, and may transmit, to the transmission device, a NACK message for code block groups including decoded code blocks that have failed the first CRC. Because the HARQ processing circuit 210 needs a certain amount of time to receive and process the retransmitted code block group, the HARQ processing circuit 210 may store in an external memory the decoded code blocks that have passed the first CRC. In response to the NACK message, the transmission device may retransmit a code block group corresponding to the NACK message to the HARQ processing circuit 210. The HARQ processing circuit 210 may combine the retransmitted code block group with a previously received codeword, decode a retransmitted code block corresponding to the code block that has failed the first CRC in the combined codeword, and perform the first CRC.

In operation S110, the HARQ processing circuit 210 may perform a second CRC on the decoded transport block by using the internal memory 220. For example, instead of generating a decoded transport block by concatenating decoded code blocks that have passed the first CRC and determining whether the second CRC has been passed based on a remainder obtained by dividing the decoded transport block by a second polynomial (or a polynomial for the second CRC), the HARQ processing circuit 210 may perform the second CRC by sequentially generating target blocks corresponding to the decoded code blocks and determining whether the second CRC has been passed by using the generated target blocks. That is, the HARQ processing circuit 210 may perform a second CRC on the decoded transport block, based on a method of using target blocks corresponding to decoded code blocks, rather than directly using the decoded transport block in the second CRC. The second CRC may be temporarily suspended while the second CRC is being performed. The internal memory 220 may store intermediate data necessary for resuming the second CRC. Thereafter, the HARQ processing circuit 210 may read the intermediate data from the internal memory 220, and resume the second CRC, based on the read-out intermediate data. For example, the HARQ processing circuit 210 may access the internal memory 220 at a faster speed than a speed for accessing the external memory 20. According to some embodiments, the HARQ processing circuit 210 may communicate with the internal memory 220 via an internal bus.

In operation S120, the HARQ processing circuit 210 may generate a decoded transport block, i.e., a decoded codeword (or decoded data in units of codewords), based on the decoded code blocks stored in the external memory 20 and the retransmitted decoded code block. For example, when results of the first CRC and the second CRC with respect to the decoded code blocks and the retransmitted decoded code block have both passed, the HARQ processing circuit 210 may read the decoded code blocks from the external memory 11, and concatenate the read-out decoded code blocks with the retransmitted decoded code block to generate the decoded transport block. The HARQ processing circuit 210 may output the decoded transport block to an upper layer (e.g., a media access control (MAC) layer).

In FIG. 3, operations S100 and S110 are performed sequentially. However, this is exemplary, and embodiments are not limited thereto, and operations S100 and S110 may be performed in parallel.

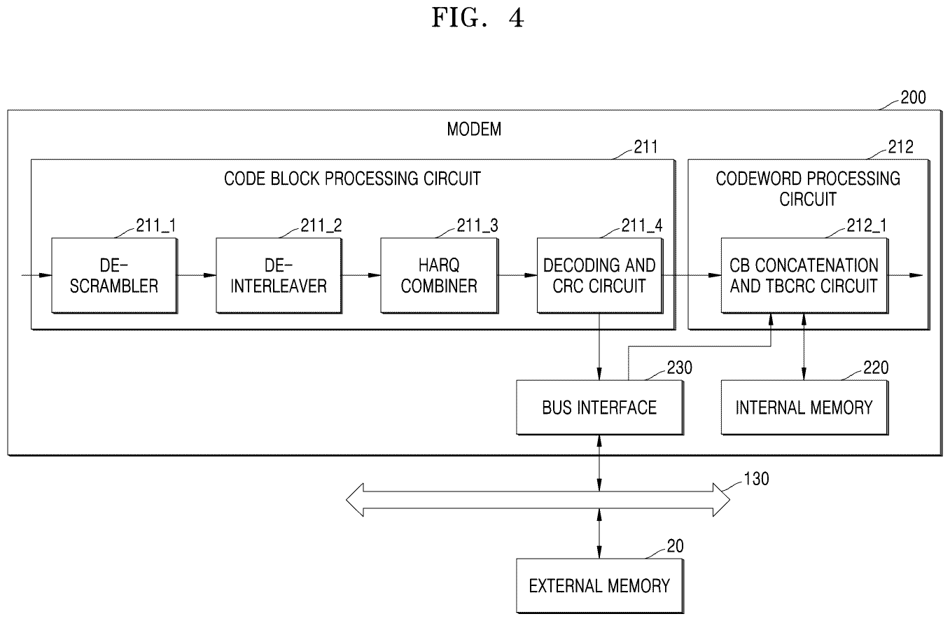

FIG. 4 is a block diagram of a modem 200 according to an embodiment. The modem 200 of FIG. 4 may be referred to as a modem chip, and the modem 200 may be connected to the external memory 20 through a bus 130.

Referring to FIG. 4, the modem 200 may include a code block processing circuit 211, a code word processing circuit 212, the internal memory 220, and a bus interface 230. The code block processing circuit 211 may be a circuit for processing a received codeword in units of code blocks, and a codeword processing circuit 212 may be a circuit for processing the received codeword in units of codewords.

In FIG. 4, the codeword received by the code block processing circuit 211 may be data that has passed an analog-to-digital converter, a synchronization detector, a channel estimator, a channel equalizer, and a log likelihood ratio (LLR) de-mapper of the modem 200.

A descrambler 211_1 may descramble a codeword, and a deinterleaver 211_2 may deinterleave the codeword to align a plurality of code blocks included in the codeword in units of code blocks. An HARQ combiner 211_3 may provide code blocks received from the deinterleaver 211_2 to a decoding and CRC circuit 211_4, or may generate combined data by combining previous code blocks with a retransmitted code block (or a retransmitted code block group) and provide the combined data to the decoding and CRC circuit 211_4.

According to an embodiment, the decoding and CRC circuit 211_4 may decode the received code blocks in units of code blocks, and may perform a first CRC on each of the decoded code blocks. The decoding and CRC circuit 211_4 may decode one code block and provide the decoded code block to the codeword processing circuit 212. The decoded code block provided to the codeword processing circuit 212 may be used in a second CRC which will be described later. When the decoding and CRC circuit 211_4 completes the first CRC on the decoded code block provided to the codeword processing circuit 212, the decoding and CRC circuit 211_4 may provide a result of the first CRC to the codeword processing circuit 212.

According to an embodiment, when there is a code block among the decoded code blocks that fails the first CRC and needs retransmission, the decoding and CRC circuit 211_4 may store code blocks among the decoded code blocks that have passed the first CRC, in the external memory 20 through the bus interface 230. That is, the bus interface 230 may store the decoded code blocks received from the decoding and CRC circuit 211_4, in the external memory 20 through the bus 130.

According to an embodiment, the codeword processing circuit 212 may include a code block (CB) concatenation and TBCRC circuit 212_1. The CB concatenation and TBCRC circuit 212_1 may sequentially generate target blocks corresponding to the decoded code blocks received from the decoding and CRC circuit 211_4, and may perform a second CRC on a decoded transport block, based on remainders obtained by dividing the target blocks by a polynomial for a second CRC. The CB concatenation and TBCRC circuit 212_1 may temporarily suspend the second CRC until a code block that has failed the first CRC among the decoded code blocks is retransmitted and the retransmitted code block is received and processed by the decoding and CRC circuit 211_4. At this time, the CB concatenation and TBCRC circuit 212_1 may store intermediate data generated in the second CRC, in the internal memory 220. Thereafter, when the retransmitted code block is decoded and passes the first CRC, the CB concatenation and TBCRC circuit 212_1 may read intermediate data from the internal memory 120 and may resume the second CRC. In detail, the CB concatenation and TBCRC circuit 212_1 may update a final remainder of a last target block, based on a target block corresponding to the read-out intermediate data and the retransmitted code block, and determine whether the second CRC has been passed, based on the updated final remainder.

According to an embodiment, when it is determined that a result of the second CRC has been passed, the CB concatenation and TBCRC circuit 212_1 may read the decoded code blocks from the external memory 20 via the bus interface 230, and may concatenate the read-out decoded code blocks to the retransmitted decoded code block to generate the decoded transport block. The CB concatenation and TBCRC circuit 212_1 may output the decoded transport block as codeword-unit data that have been successfully decoded.

According to some embodiments, the CB concatenation and TBCRC circuit 212_1 may be connected to the internal memory 220 via an internal bus.

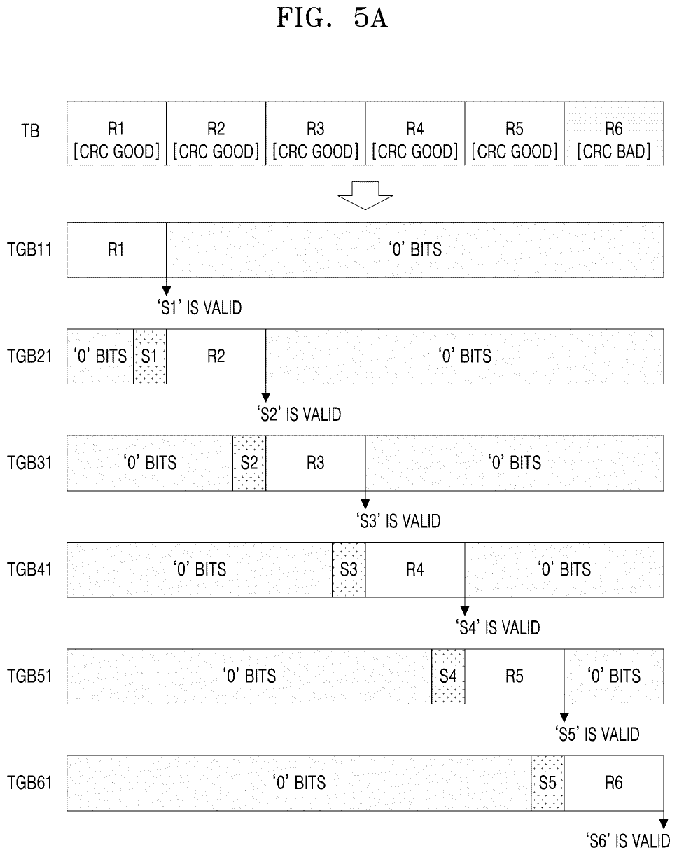

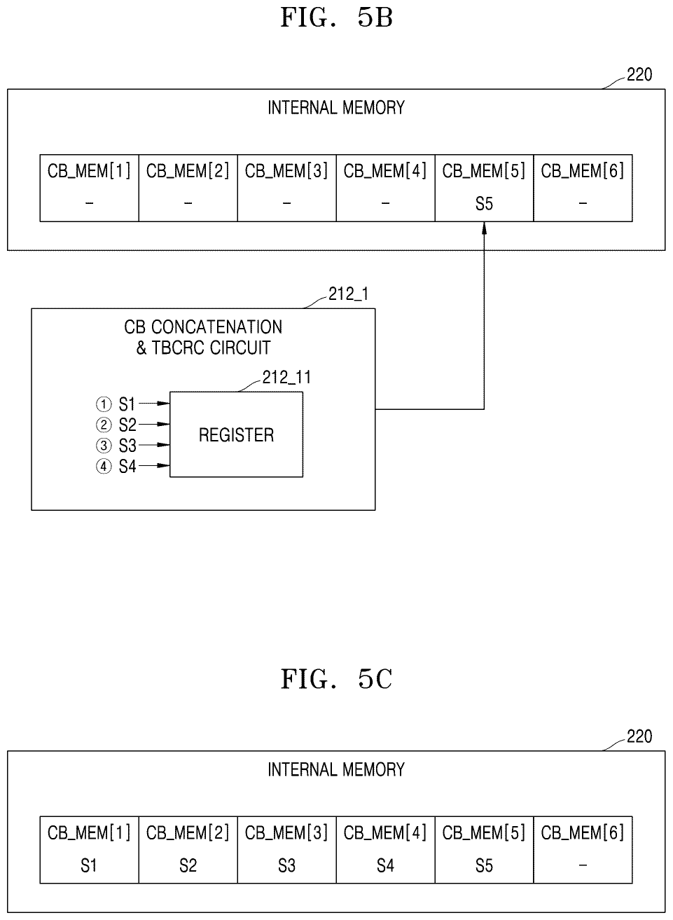

FIGS. 5A through 5C are diagrams for explaining a second CRC by a modem chip, according to an embodiment. An operation of the modem chip described below with reference to FIGS. 5A through 5C may be performed by the CB concatenation and TBCRC circuit 212_1 and the internal memory 220 of FIG. 4. FIG. 4 will now be further referenced to aid understanding.

Referring to FIG. 5A, a transport block TB may be expressed as a sum of a plurality of polynomials as in Equation 1 below.

$$R = R 1 + R 2 + R 3 + R 4 + R 5 + R 6 \qquad [ Equation 1 ]$$

A ‘R’ polynomial may correspond to the transport block TB, a ‘R1’ polynomial may correspond to a first transport block, a ‘R2’ may correspond to a second transport block, a ‘R3’ may correspond to a third transport block, a ‘R4’ may correspond to a fourth transport block, a ‘R5’ may correspond to a fifth transport block, and a ‘R6’ may correspond to a sixth transport block.

When a modular arithmetic is performed on the transport block TB by using the ‘g_{TBCRC}’ polynomial, the modular arithmetic may be expressed as Equation 2 below.

$$S = remainder ( \frac{R}{{g}_{T B C R C}} ) = remainder ( \frac{R 1}{{g}_{T B C R C}} ) + remainder ( \frac{R 2}{{g}_{T B C R C}} ) + remainder ( \frac{R 3}{{g}_{T B C R C}} ) + remainder ( \frac{R 4}{{g}_{T B C R C}} ) + remainder ( \frac{R 5}{{g}_{T B C R C}} ) + remainder ( \frac{R 6}{{g}_{T B C R C}} ) \qquad [ Equation 2 ]$$

A remainder obtained by dividing the ‘R’ polynomial by a ‘g_{TBCRC}’ polynomial may conform to a sum of a remainder obtained by dividing the ‘R1’ polynomial by a ‘g_{TBCRC}’ polynomial, a remainder obtained by dividing the ‘R2’ polynomial by a ‘g_{TBCRC}’ polynomial, a remainder obtained by dividing the ‘R3’ polynomial by a ‘g_{TBCRC}’ polynomial, a remainder obtained by dividing the ‘R4’ polynomial by ‘g_{TBCRC}’ polynomial, a remainder obtained by dividing the ‘R5’ polynomial by a ‘g_{TBCRC}’ polynomial, and a remainder obtained by dividing the ‘R6’ polynomial by a ‘g_{TBCRC}’ polynomial (or may conform to a remainder obtained by dividing the sum by the ‘g_{TBCRC}’ polynomial).

Taking into account the linear characteristics of the remainders as above, a second CRC according to an embodiment may be performed. Hereinafter, it is assumed that the transport block TB includes first, second, third, fourth, fifth, and sixth code blocks R1, R2, R3, R4, R5, and R6, that the first through sixth code blocks R1 through R6 are decoded in units of code blocks by the decoding and CRC circuit 211_4, and that a first CRC has been completed. It is also assumed that the first through fifth code blocks R1 through R5 are determined as ‘CRC GOOD’ and thus have passed the first CRC, and that the sixth code block R6 is determined as ‘CRC BAD’ and thus have failed the first CRC.

The CB concatenation and TBCRC circuit 212_1 may generate a first target block TGB11 including the first code block R1 and zero bits. For example, the CB concatenation and TBCRC circuit 212_1 may place the first code block R1 at the same position as a position in the transport block TB, and fill the area after the first code block R1 with the zero bits to generate the first target block TGB11.

The CB concatenation and TBCRC circuit 212_1 may divide the first target block TGB11 by a polynomial for the second CRC to generate a first remainder S1. Thereafter, the CB concatenation and TBCRC circuit 212_1 may determine, as valid data, the first remainder S1 corresponding to the first code block R1 that has passed the first CRC, and may use the first remainder S1 to generate a second target block TGB21.

The CB concatenation and TBCRC circuit 212_1 may generate a second target block TGB21 including the first remainder S1, the second code block R2, and zero bits. For example, the CB concatenation and TBCRC circuit 212_1 may place the second code block R2 at the same position as a position in the transport block TB, place the first remainder S1 in front of the second code block R2, and fill other portions of the transport block TB with the zero bits to generate the second target block TGB21.

The CB concatenation and TBCRC circuit 212_1 may divide the second target block TGB21 by a polynomial for the second CRC to generate a second remainder S2. Thereafter, the CB concatenation and TBCRC circuit 212_1 may determine, as valid data, the second remainder S2 corresponding to the second code block R2 that has passed the first CRC, and may use the second remainder S2 to generate a third target block TGB31.

The CB concatenation and TBCRC circuit 212_1 may generate a third target block TGB31 including the second remainder S2, the third code block R3, and zero bits. For example, the CB concatenation and TBCRC circuit 212_1 may place the third code block R3 at the same position as a position in the transport block TB, place the second remainder S2 in front of the third code block R3, and fill other portions of the transport block TB with the zero bits to generate the third target block TGB31.

The CB concatenation and TBCRC circuit 212_1 may divide the third target block TGB31 by a polynomial for the second CRC to generate a third remainder S3. Thereafter, the CB concatenation and TBCRC circuit 212_1 may determine, as valid data, the third remainder S3 corresponding to the third code block R3 that has passed the first CRC, and may use the third remainder S3 to generate a fourth target block TGB41.

The CB concatenation and TBCRC circuit 212_1 may generate a fourth target block TGB41 including the third remainder S3, the fourth code block R4, and zero bits. For example, the CB concatenation and TBCRC circuit 212_1 may place the fourth code block R4 at the same position as a position in the transport block TB, place the third remainder S3 in front of the fourth code block R4, and fill other portions of the transport block TB with the zero bits to generate the fourth target block TGB41.

The CB concatenation and TBCRC circuit 212_1 may divide the fourth target block TGB41 by a polynomial for the second CRC to generate a fourth remainder S4. Thereafter, the CB concatenation and TBCRC circuit 212_1 may determine, as valid data, the fourth remainder S4 corresponding to the fourth code block R4 that has passed the first CRC, and may use the fourth remainder S4 to generate a fifth target block TGB51.

The CB concatenation and TBCRC circuit 212_1 may generate a fifth target block TGB51 including the fourth remainder S4, the fifth code block R5, and zero bits. For example, the CB concatenation and TBCRC circuit 212_1 may place the fifth code block R5 at the same position as a position in the transport block TB, place the fourth remainder S4 in front of the fifth code block R5, and fill other portions of the transport block TB with the zero bits to generate the fifth target block TGB51.

The CB concatenation and TBCRC circuit 212_1 may divide the fifth target block TGB51 by a polynomial for the second CRC to generate a fifth remainder S5. Thereafter, the CB concatenation and TBCRC circuit 212_1 may determine, as valid data, the fifth remainder S5 corresponding to the fifth code block R5 that has passed the first CRC, and may use the fifth remainder S5 to generate a sixth target block TGB61.

The CB concatenation and TBCRC circuit 212_1 may generate a sixth target block TGB61 including the fifth remainder S5, the sixth code block R6, and zero bits. For example, the CB concatenation and TBCRC circuit 212_1 may place the sixth code block R6 at the same position as a position in the transport block TB, place the fifth remainder S5 in front of the sixth code block R6, and fill other portions of the transport block TB with the zero bits to generate the sixth target block TGB61.

The CB concatenation and TBCRC circuit 212_1 may divide the sixth target block TGB61 by a polynomial for the second CRC to generate a sixth remainder S6. Thereafter, the CB concatenation and TBCRC circuit 212_1 may determine, as invalid data, the sixth remainder S6 corresponding to the sixth code block R6 that has failed the first CRC. According to an embodiment, the CB concatenation and TBCRC circuit 212_1 may skip an operation for generating the sixth target block TGB61 corresponding to the sixth code block R6 that has failed the first CRC or obtaining the sixth remainder S6 corresponding to the sixth target block TGB61.

The sixth target block TGB61 is a last target block, and the sixth remainder S6 corresponding to the sixth target block TGB61 may correspond to a final remainder. However, in FIG. 5A, due to failure of the sixth code block R6 in the first CRC, the current sixth remainder S6 may not be used to determine whether the second CRC has passed or failed, and may be updated in the future to become a valid final remainder. Embodiments thereof will be described in detail later.

According to an embodiment, respective data lengths of the first through sixth target blocks TGB11 through TGB61 may conform to a data length of the transport block TB. According to an embodiment, the respective data lengths of the first through sixth target blocks TGB11 through TGB61 may be different from each other.

Referring further to FIG. 5B, the CB concatenation and TBCRC circuit 212_1 may include a register 212_11. The register 212_11 may correspond to a buffer for temporarily storing a remainder generated in the second CRC. For example, the register 212_11 may be implemented as any one of various types of flip-flops. The CB concatenation and TBCRC circuit 212_1 may store, in the register 212_11, the first through fourth remainders S1 through S4 sequentially generated in FIG. 5A. For example, a remainder stored in the register 212_11 may be used when generating a next remainder. For example, the register 212_11 may include a memory space capable of storing one remainder, and, when a new remainder is received, the previously stored remainder may be deleted. Thereafter, in response to the sixth code block R6 having failed the first CRC, the CB concatenation and TBCRC circuit 212_1 may store, in the internal memory 220, the fifth remainder S5 generated at the very last among valid remainders S1 through S5. According to an embodiment, the internal memory 220 may include first, second, third, fourth, fifth, and sixth memory elements CB_MEM[1], CB_MEM[2], CB_MEM[3], CB_MEM[4], CB_MEM[5], and CB_MEM[6] respectively corresponding to the first, second, third, fourth, fifth, and sixth code blocks R1, R2, R3, R4, R5, and R6 (or the first, second, third, fourth, fifth, and sixth target blocks TGB11, TGB11, TGB21, TGB31, TGB41, TGB51, and TGB61). For example, the fifth memory element CB_MEM[5] may store the fifth remainder S5. The intermediate data of the second CRC stored in the internal memory 220 may include the fifth remainder S5.

That is, as in FIG. 5B, when valid remainders (e.g., S1 through S5) are generated consecutively, the CB concatenation and TBCRC circuit 212_1 may store previous remainders (e.g., S1 through S4) in the register 212_11, and may selectively store only a very last-generated valid remainder (e.g., S5) in the internal memory 220.

Referring further to FIG. 5C, the CB concatenation and TBCRC circuit 212_1 may sequentially store the valid first through fifth remainders S1 through S5 generated during the second CRC, in the internal memory 220. For example, the first memory element CB_MEM[1] may store the first remainder S1, the second memory element CB_MEM[2] may store the second remainder S2, the third memory element CB_MEM[3] may store the third remainder S3, the fourth memory element CB_MEM[4] may store the fourth remainder S4, and the fifth memory element CB_MEM[5] may store the fifth remainder S5. The intermediate data of the second CRC stored in the internal memory 220 may include the first through fifth remainders S1 through S5.

In other words, as in FIG. 5C, the CB concatenation and TBCRC circuit 212_1 may store all valid remainders in the internal memory 220.

The embodiment of FIG. 5A is merely exemplary, and thus embodiments are not limited thereto. Remainders for the second CRC may be generated in various ways. The embodiments of FIGS. 5B and 5C are merely exemplary, and thus embodiments are not limited thereto. In various ways, the intermediate data of the second CRC may be stored in the internal memory 220.

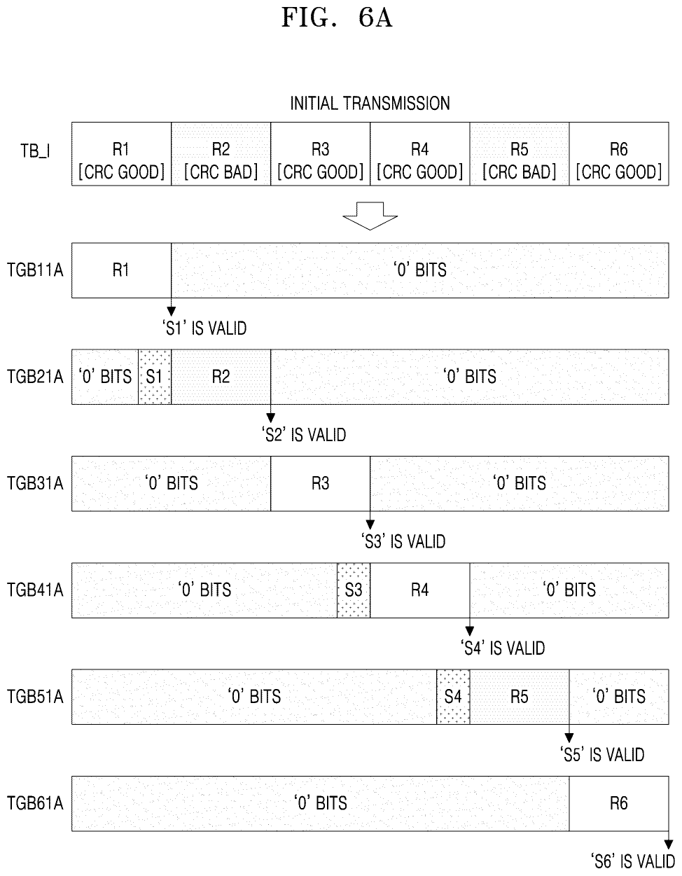

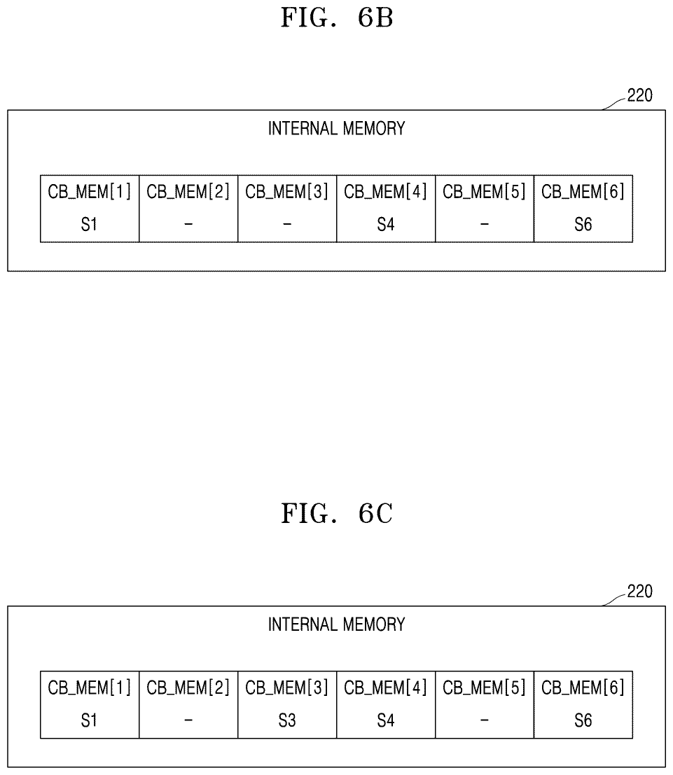

FIGS. 6A through 6C are diagrams for explaining a second CRC by a modem chip in detail, according to an embodiment. FIG. 4 will now be further referenced to aid understanding.

Referring further to FIG. 6A, a transport block TB_1 initially transmitted may include first, second, third, fourth, fifth, and sixth code blocks R1, R2, R3, R4, R5, and R6, and the first through sixth code blocks R1 through R6 may be decoded in units of code blocks by the decoding and CRC circuit 211_4 and may have completed a first CRC. The first, third, fourth, and sixth code blocks R1, R3, R4, and R6 may be determined as ‘CRC GOOD’ and thus may have passed the first CRC, and the second and fifth code block R2 and R5 may be determined as ‘CRC BAD’ and thus have failed the first CRC.

The CB concatenation and TBCRC circuit 212_1 may generate a first target block TGB11A including the first code block R1 and zero bits. For example, the CB concatenation and TBCRC circuit 212_1 may place the first code block R1 at the same position as a position in the transport block TB_1, and fill the area after the first code block R1 with the zero bits to generate the first target block TGB11A.

The CB concatenation and TBCRC circuit 212_1 may divide the first target block TGB11A by a polynomial for the second CRC to generate a first remainder S1. Thereafter, the CB concatenation and TBCRC circuit 212_1 may determine, as valid data, the first remainder S1 corresponding to the first code block R1 that has passed the first CRC, and may use the first remainder S1 to generate a second target block TGB21A.

The CB concatenation and TBCRC circuit 212_1 may generate a second target block TGB21A including the first remainder S1, the second code block R2, and zero bits. For example, the CB concatenation and TBCRC circuit 212_1 may place the second code block R2 at the same position as a position in the transport block TB_1, place the first remainder S1 in front of the second code block R2, and fill other portions of the transport block TB_1 with the zero bits to generate the second target block TGB21A.

The CB concatenation and TBCRC circuit 212_1 may divide the second target block TGB21A by a polynomial for the second CRC to generate a (2_1)th remainder S2_1. Thereafter, the CB concatenation and TBCRC circuit 212_1 may determine, as invalid data, the (2_1)th remainder S2_1 corresponding to the second code block R2 that has failed the first CRC, and may not use the (2_1)th remainder S2_1 to generate a third target block TGB31A.

The CB concatenation and TBCRC circuit 212_1 may generate a third target block TGB31A including the third code block R3 and zero bits. For example, the CB concatenation and TBCRC circuit 212_1 may place the third code block R3 at the same position as a position in the transport block TB_1, and fill the other portions of the transport block TB_1 (OK?) with the zero bits to generate the third target block TGB31A.

The CB concatenation and TBCRC circuit 212_1 may divide the third target block TGB31A by a polynomial for the second CRC to generate a third remainder S3. Thereafter, the CB concatenation and TBCRC circuit 212_1 may determine, as valid data, the third remainder S3 corresponding to the third code block R3 that has passed the first CRC, and may use the third remainder S3 to generate a fourth target block TGB41A.

The CB concatenation and TBCRC circuit 212_1 may generate a fourth target block TGB41A including the third remainder S3, the fourth code block R4, and zero bits. For example, the CB concatenation and TBCRC circuit 212_1 may place the fourth code block R4 at the same position as a position in the transport block TB_1, place the third remainder S3 in front of the fourth code block R4, and fill other portions of the transport block TB_1 with the zero bits to generate the fourth target block TGB41A.

The CB concatenation and TBCRC circuit 212_1 may divide the fourth target block TGB41A by a polynomial for the second CRC to generate a fourth remainder S4. Thereafter, the CB concatenation and TBCRC circuit 212_1 may determine, as valid data, the fourth remainder S4 corresponding to the fourth code block R4 that has passed the first CRC, and may use the fourth remainder S4 to generate a fifth target block TGB51A.

The CB concatenation and TBCRC circuit 212_1 may generate a fifth target block TGB51A including the fourth remainder S4, the fifth code block R5, and zero bits. For example, the CB concatenation and TBCRC circuit 212_1 may place the fifth code block R5 at the same position as a position in the transport block TB_1, place the fourth remainder S4 in front of the fifth code block R5, and fill the other portions of the transport block TB_1 with the zero bits to generate the fifth target block TGB51A.

The CB concatenation and TBCRC circuit 212_1 may divide the fifth target block TGB51A by a polynomial for the second CRC to generate a (5_1)th remainder S5_1. Thereafter, the CB concatenation and TBCRC circuit 212_1 may determine, as invalid data, the (5_1)th remainder S5_1 corresponding to the fifth code block R5 that has failed the first CRC, and may not use the (5_1)th remainder S5_1 to generate a sixth target block TGB61A.

The CB concatenation and TBCRC circuit 212_1 may generate a sixth target block TGB61A including the sixth code block R6 and zero bits. For example, the CB concatenation and TBCRC circuit 212_1 may place the sixth code block R6 at the same position as a position in the transport block TB_1, and fill the other portions of the transport block TB_1 with the zero bits to generate the sixth target block TGB61A.

The CB concatenation and TBCRC circuit 212_1 may divide the sixth target block TGB61A by a polynomial for the second CRC to generate a sixth remainder S6. Thereafter, the CB concatenation and TBCRC circuit 212_1 may determine, as valid data, the sixth remainder S6 corresponding to the sixth code block R6 that has passed the first CRC.

Referring further to FIG. 6B, the CB concatenation and TBCRC circuit 212_1 may temporarily suspend the second CRC, based on the failure of the first CRC with respect to the second and fifth code blocks R2 and R5, and may resume the second CRC, based on a result of the processing with respect to retransmitted second and fifth code blocks in the decoding and CRC circuit 211_4. According to an embodiment, in response to the second CRC being temporarily suspended, the CB concatenation and TBCRC circuit 212_1 may store intermediate data including the first, fourth, and sixth remainders S1, S4, and S6 determined as valid data, in the internal memory 220.

For example, the CB concatenation and TBCRC circuit 212_1 may store the first remainder S1 in the first memory element CB_MEM[1], store the fourth remainder S4 generated at the very last among the consecutively-generated third and fourth remainders S3 and S4, in the fourth memory element CB_MEM[4], and store the sixth remainder S6 in the sixth memory element CB_MEM[6].

Referring further to FIG. 6C, in response to the second CRC being temporarily suspended, the CB concatenation and TBCRC circuit 212_1 may store intermediate data including the first, third, fourth, and sixth remainders S1, S3, S4, and S6 determined as valid data, in the internal memory 220.

For example, the CB concatenation and TBCRC circuit 212_1 may store the first remainder S1 in the first memory element CB_MEM[1], store the third remainder S3 in the third memory element CB_MEM[3], store the fourth remainder S4 in the fourth memory element CB_MEM[4], and store the sixth remainder S6 in the sixth memory element CB_MEM[6].

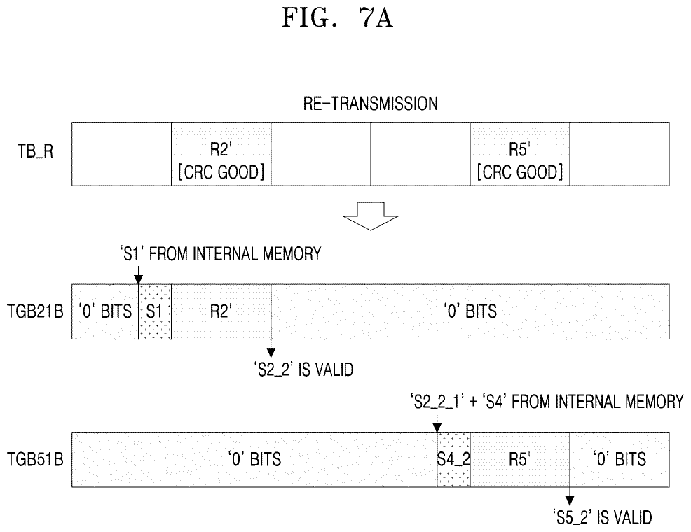

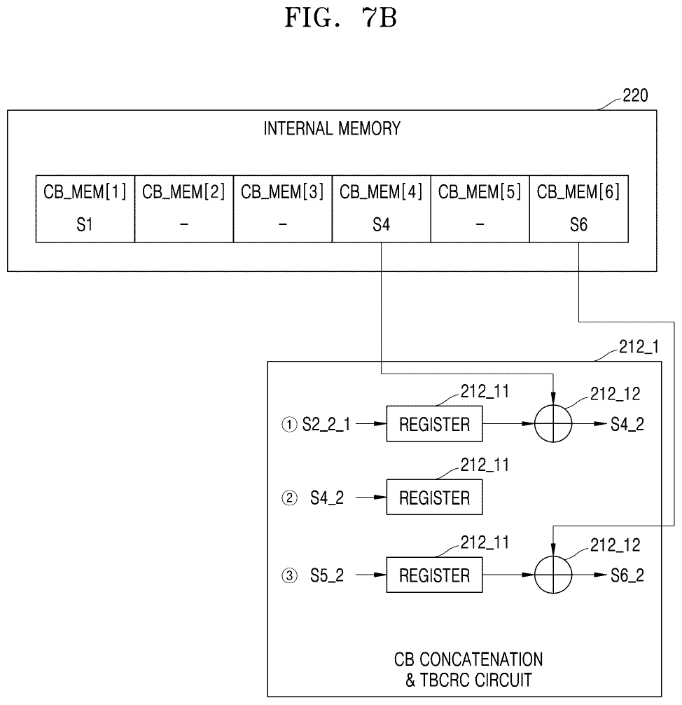

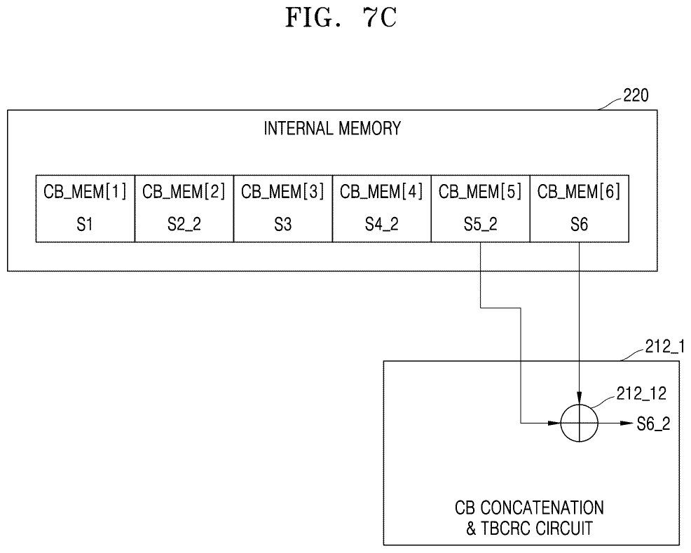

FIGS. 7A through 7C are diagrams for explaining a second CRC by a modem chip in detail, according to an embodiment. Hereinafter, to help understanding, FIG. 4 is further referred to, the contents of FIG. 6A are assumed in FIG. 7A, the contents of FIG. 6B are assumed in FIG. 7A, and the contents of FIG. 6C are assumed in FIG. 7C.

Referring to FIG. 7A, a retransmitted transmission block TB_R may include a retransmitted second code block R2′ and a retransmitted fifth code block R5′. The aforementioned HARQ retransmission of an NR network is performed in units of code block groups. However, for convenience of description, the retransmitted second code block R2′ and the retransmitted fifth code block R5′ used in the second CRC by the CB concatenation and TBCRC circuit 212_1 are focused on in FIG. 7A. The retransmitted second code block R2′ and the retransmitted fifth code block R5′ may be decoded in units of code blocks by the decoding and CRC circuit 211_4, and may be determined as ‘CRC GOOD’ and thus may be in a state of having passed the first CRC.

The CB concatenation and TBCRC circuit 212_1 may read the first remainder S1 from the internal memory 220, and may generate a second target block TGB21B including the read-out first remainder S1, the retransmitted second code block R2′, and zero bits. For example, the CB concatenation and TBCRC circuit 212_1 may place the retransmitted second code block R2′ at the same position as a position in the transmission block TB_R, place the first remainder S1 in front of the retransmitted second code block R2′, and fill the other portions of the transmission block TB_R with the zero bits to generate the second target block TGB21B.

The CB concatenation and TBCRC circuit 212_1 may divide the second target block TGB21B by a polynomial for the second CRC to generate a (2_2)th remainder S2_2. Thereafter, the CB concatenation and TBCRC circuit 212_1 may determine, as valid data, the (2_2)th remainder S2_2 corresponding to the retransmitted second code block R2′ that has passed the first CRC, and may use the (2_2)th remainder S2_2 to generate a fifth target block TGB51B.

The CB concatenation and TBCRC circuit 212_1 may read the fourth remainder S4 from the internal memory 220, and may sum the read-out fourth remainder S4 with a (2_2_1)th remainder S2_2_1 generated from the (2_2)th remainder S2_2, to thereby generate a (4_2)th remainder S4_2. For example, the (2_2_1)th remainder S2_2_1 may be generated by dividing, by a polynomial for the second CRC, data generated by attaching ‘0’ bits conforming to the number of code blocks (e.g., 2) between the retransmitted second code block R2′ and the retransmitted fifth code block R5′ to an end of the (2_2)th remainder S2_2. The CB concatenation and TBCRC circuit 212_1 may generate a fifth target block TGB51B including the (4_2)th remainder S4_2, the retransmitted fifth code block R5′, and zero bits. For example, the CB concatenation and TBCRC circuit 212_1 may place the retransmitted fifth code block R5′ at the same position as a position in the transport block TB_R, place the (4_2)th remainder S4_2 in front of the retransmitted fifth code block R5′, and fill the other portions of the transport block TB_R with the zero bits to generate the fifth target block TGB51B.

The CB concatenation and TBCRC circuit 212_1 may divide the fifth target block TGB51B by a polynomial for the second CRC to generate a (5_2)th remainder S5_2. Thereafter, the CB concatenation and TBCRC circuit 212_1 may determine, as valid data, the (5_2)th remainder S5_2 corresponding to the retransmitted fifth code block R5′ that has passed the first CRC.

Referring further to FIG. 7B, the CB concatenation and TBCRC circuit 212_1 may include a register 212_11 and an adder 212_12. The CB concatenation and TBCRC circuit 212_1 may store the (2_2_1)th remainder S2_2_1 generated in FIG. 7A in the register 212_11, and may add the fourth remainder S4 read from the fourth memory element CB_MEM[4] of the internal memory 220 to the (2_2_1)th remainder S2_2_1 stored in the register 212_11 through the adder 212_12 to generate the (4_2)th remainder S4_2.

The CB concatenation and TBCRC circuit 212_1 may store the (4_2)th remainder S4_2 in the register 212_11, and may use the (4_2)th remainder S4_2 stored in the register 212_11 to generate the fifth target block TGB51B.

Then, the CB concatenation and TBCRC circuit 212_1 may store the (5_2)th remainder S5_2 generated in FIG. 7A in the register 212_11, and may add the sixth remainder S6 read from the sixth memory element CB_MEM[6] of the internal memory 220 to the (5_2)th remainder S5_2 stored in the register 212_11 through the adder 212_12 to generate a (6_2)th remainder S6_2. In other words, the CB concatenation and TBCRC circuit 212_1 may update the sixth remainder S6 with the (6_2)th remainder S6_2, and may determine whether the second CRC has passed or failed based on the (6_2)th remainder S6_2, which is a final remainder. For example, when the (6_2)th remainder S6_2 is ‘0’, the concatenation and TBCRC circuit 212_1 may determine that the decoded transport block has passed the second CRC.

Referring further to FIG. 7C, the CB concatenation and TBCRC circuit 212_1 may include an adder 212_12. The CB concatenation and TBCRC circuit 212_1 may store, in the internal memory 220, the (2_2)th, (4_2)th, and (5_2)th remainders S2_2, S4_2, and S5_2 generated in FIG. 7A.

For example, the CB concatenation and TBCRC circuit 212_1 may store the (2_2)th remainder S2_2 in the second memory element CB_MEM[2], store the (4_2)th remainder S4_2 in the fourth memory element CB_MEM[4], and store the (5_2)th remainder S5_2 in the fifth memory element CB_MEM[5].

Then, the CB concatenation and TBCRC circuit 212_1 may add the (5_2)th remainder S5_2 read from the fifth memory element CB_MEM[5] of the internal memory 220 to the sixth remainder S6 read from the sixth memory element CB_MEM[6] through the adder 212_12 to generate the (6_2)th remainder S6_2. In other words, the CB concatenation and TBCRC circuit 212_1 may update the sixth remainder S6 with the (6_2)th remainder S6_2, and may determine whether the second CRC has passed or failed based on the (6_2)th remainder S6_2, which is a final remainder.

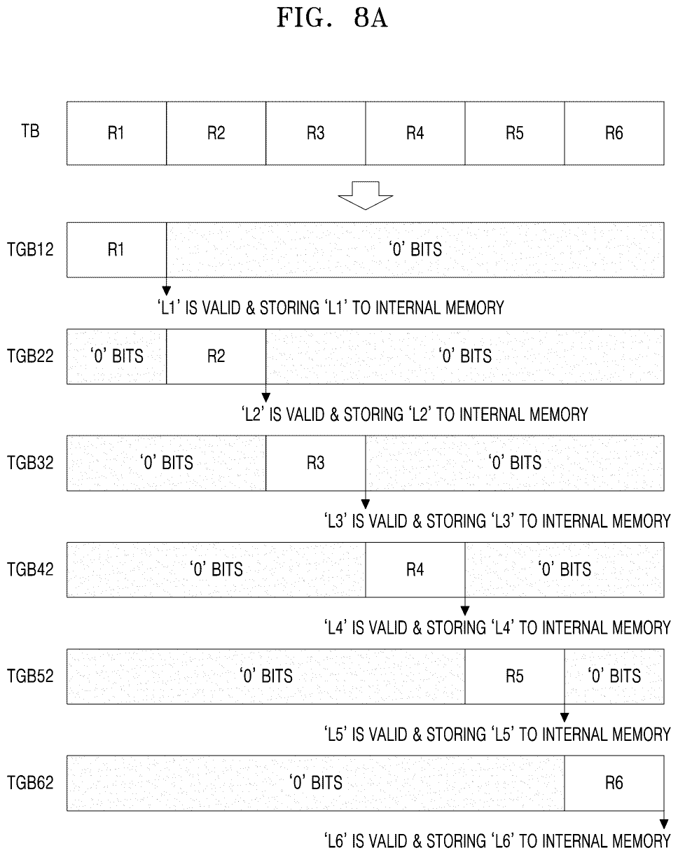

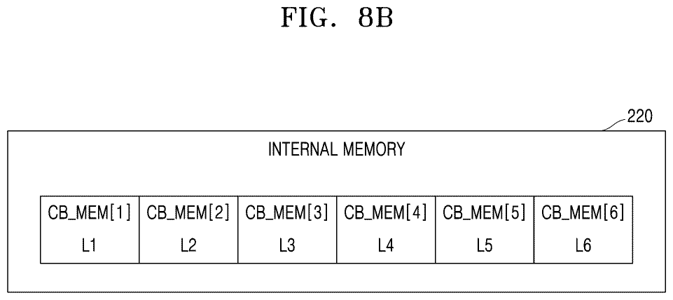

FIGS. 8A and 8B are diagrams for explaining a second CRC by a modem chip, according to an embodiment. A method of the second CRC, which will now be described with reference to FIGS. 8A and 8B, may be different from the method of the second CRC described above with reference to FIGS. 5A through 7C. An operation of the modem chip to be described below with reference to FIGS. 8A and 8B may be performed by the CB concatenation and TBCRC circuit 212_1 and the internal memory 220 of FIG. 4. FIG. 4 will now be further referenced to aid understanding.

Referring to FIG. 8A, it is assumed that the transport block TB includes first, second, third, fourth, fifth, and sixth code blocks R1, R2, R3, R4, R5, and R6, that the first through sixth code blocks R1 through R6 are decoded in units of code blocks by the decoding and CRC circuit 211_4, and that a first CRC has been completed. It is also assumed that the first through sixth code blocks R1 through R6 are determined as ‘CRC GOOD’ and thus have passed the first CRC.

The CB concatenation and TBCRC circuit 212_1 may generate a first target block TGB12 including the first code block R1 and zero bits. For example, the CB concatenation and TBCRC circuit 212_1 may place the first code block R1 at the same position as a position in the transport block TB, and fill the area after the first code block R1 with the zero bits to generate a first target block TGB12. The CB concatenation and TBCRC circuit 212_1 may divide the first target block TGB12 by a polynomial for the second CRC to generate a first remainder L1. Thereafter, the CB concatenation and TBCRC circuit 212_1 may determine, as valid data, the first remainder L1 corresponding to the first code block R1 that has passed the first CRC, and may store the first remainder L1 in the internal memory 220.

The CB concatenation and TBCRC circuit 212_1 may generate a second target block TGB22 including the second code block R2 and zero bits. For example, the CB concatenation and TBCRC circuit 212_1 may place the second code block R2 at the same position as a position in the transport block TB, and fill the areas before and after the second code block R2 with the zero bits to generate the second target block TGB22. The CB concatenation and TBCRC circuit 212_1 may divide the second target block TGB22 by a polynomial for the second CRC to generate a second remainder L2. Thereafter, the CB concatenation and TBCRC circuit 212_1 may determine, as valid data, the second remainder L2 corresponding to the second code block R2 that has passed the first CRC, and may store the second remainder L2 in the internal memory 220.

The CB concatenation and TBCRC circuit 212_1 may generate a third target block TGB32 including the third code block R3 and zero bits. For example, the CB concatenation and TBCRC circuit 212_1 may place the third code block R3 at the same position as a position in the transport block TB, and fill the areas before and after the third code block R3 with the zero bits to generate the third target block TGB32. The CB concatenation and TBCRC circuit 212_1 may divide the third target block TGB32 by a polynomial for the second CRC to generate a third remainder L3. Thereafter, the CB concatenation and TBCRC circuit 212_1 may determine, as valid data, the third remainder L3 corresponding to the third code block R3 that has passed the first CRC, and may store the third remainder L3 in the internal memory 220.

The CB concatenation and TBCRC circuit 212_1 may generate a fourth target block TGB42 including the fourth code block R4 and zero bits. For example, the CB concatenation and TBCRC circuit 212_1 may place the fourth code block R4 at the same position as a position in the transport block TB, and fill the areas before and after the fourth code block R4 with the zero bits to generate the fourth target block TGB42. The CB concatenation and TBCRC circuit 212_1 may divide the fourth target block TGB42 by a polynomial for the second CRC to generate a fourth remainder LA. Thereafter, the CB concatenation and TBCRC circuit 212_1 may determine, as valid data, the fourth remainder LA corresponding to the fourth code block R4 that has passed the first CRC, and may store the fourth remainder LA in the internal memory 220.

The CB concatenation and TBCRC circuit 212_1 may generate a fifth target block TGB52 including the fifth code block R5 and zero bits. For example, the CB concatenation and TBCRC circuit 212_1 may place the fifth code block R5 at the same position as a position in the transport block TB, and fill the areas before and after the fifth code block R5 with the zero bits to generate the fifth target block TGB52. The CB concatenation and TBCRC circuit 212_1 may divide the fifth target block TGB52 by a polynomial for the second CRC to generate a fifth remainder L5. Thereafter, the CB concatenation and TBCRC circuit 212_1 may determine, as valid data, the fifth remainder L5 corresponding to the fifth code block R5 that has passed the first CRC, and may store the fifth remainder L5 in the internal memory 220.

The CB concatenation and TBCRC circuit 212_1 may generate a sixth target block TGB62 including the sixth code block R6 and zero bits. For example, the CB concatenation and TBCRC circuit 212_1 may place the sixth code block R6 at the same position as a position in the transport block TB, and fill the area before the sixth code block R6 with the zero bits to generate the sixth target block TGB62. The CB concatenation and TBCRC circuit 212_1 may divide the sixth target block TGB62 by a polynomial for the second CRC to generate a sixth remainder L6. Thereafter, the CB concatenation and TBCRC circuit 212_1 may determine, as valid data, the sixth remainder L6 corresponding to the sixth code block R6 that has passed the first CRC, and may store the sixth remainder L6 in the internal memory 220.

Referring further to FIG. 8B, the CB concatenation and TBCRC circuit 212_1 may sequentially store the valid first through sixth remainders L1 through L6 generated during the second CRC, in the internal memory 220. For example, the first memory element CB_MEM[1] may store the first remainder L1, the second memory element CB_MEM[2] may store the second remainder L2, the third memory element CB_MEM[3] may store the third remainder L3, the fourth memory element CB_MEM[4] may store the fourth remainder LA, the fifth memory element CB_MEM[5] may store the fifth remainder L5, and the fifth memory element CB_MEM[6] may store the fifth remainder L6.

According to an embodiment, the CB concatenation and TBCRC circuit 212_1 may read the first through sixth remainders L1 through L6 from the internal memory 220, add up the read-out first through sixth remainders L1 through L6, and then determine whether the second CRC has passed or failed, based on a result of the addition.

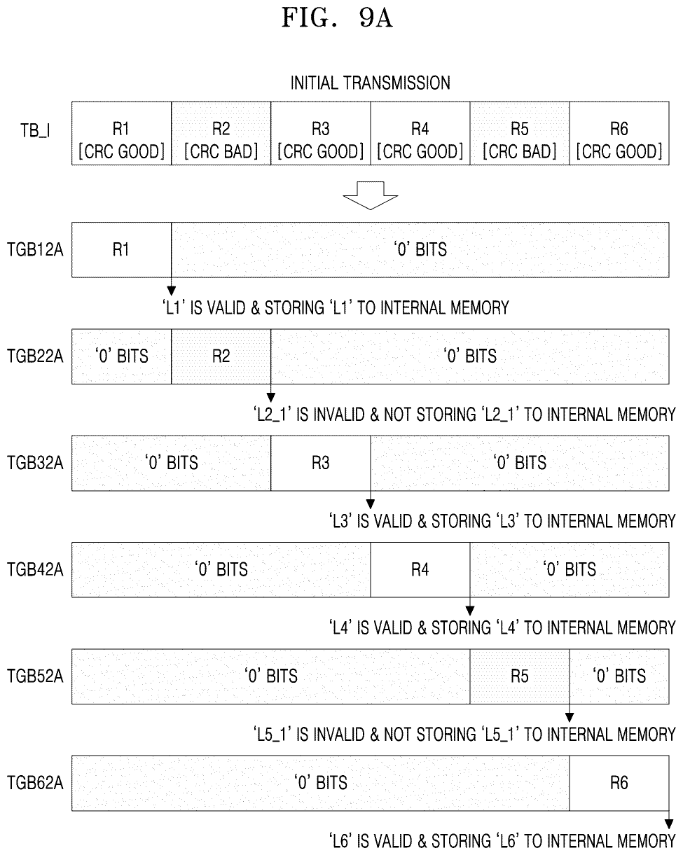

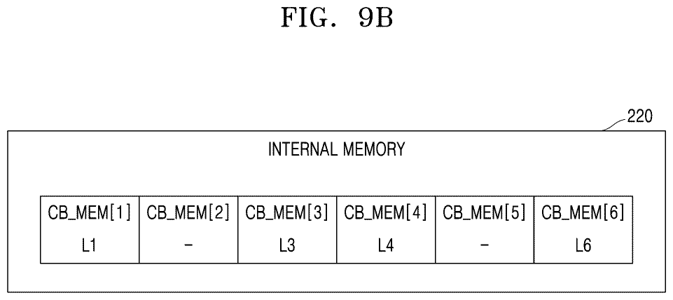

FIGS. 9A and 9B are diagrams for explaining a second CRC by a modem chip in detail, according to an embodiment. In FIGS. 9A and 9B, embodiments related to the contents described above with reference to FIGS. 8A and 8B will be described. FIG. 4 will now be further referenced to aid understanding.

Referring to FIG. 9A, the initially-transmitted transport block TB_1 may include first, second, third, fourth, fifth, and sixth code blocks R1, R2, R3, R4, R5, and R6, and the first through sixth code blocks R1 through R6 may be decoded in units of code blocks by the decoding and CRC circuit 211_4 and may have completed a first CRC. The first, third, fourth, and sixth code blocks R1, R3, R4, and R6 may be determined as ‘CRC GOOD’ and thus may have passed the first CRC, and the second and fifth code block R2 and R5 may be determined as ‘CRC BAD’ and thus have failed the first CRC.

The CB concatenation and TBCRC circuit 212_1 may divide a first target block TGB12A including the first code block R1 by a polynomial for the second CRC to generate a first remainder L1. Thereafter, the CB concatenation and TBCRC circuit 212_1 may determine, as valid data, the first remainder L1 corresponding to the first code block R1 that has passed the first CRC, and may store the first remainder L1 in the internal memory 220.

The CB concatenation and TBCRC circuit 212_1 may divide a second target block TGB22A including the second code block R2 by a polynomial for the second CRC to generate a (2_1)th remainder L2_1. Thereafter, the CB concatenation and TBCRC circuit 212_1 may determine, as invalid data, the (2_1)th remainder L2_1 corresponding to the second code block R2 that has failed the first CRC, and may not store the (2_1)th remainder L2_1 in the internal memory 220.

The CB concatenation and TBCRC circuit 212_1 may divide a third target block TGB32A including the third code block R3 by a polynomial for the second CRC to generate a third remainder L3. Thereafter, the CB concatenation and TBCRC circuit 212_1 may determine, as valid data, the third remainder L3 corresponding to the third code block R3 that has passed the first CRC, and may store the third remainder L3 in the internal memory 220.

The CB concatenation and TBCRC circuit 212_1 may divide a fourth target block TGB42A including the fourth code block R4 by a polynomial for the second CRC to generate a fourth remainder LA. Thereafter, the CB concatenation and TBCRC circuit 212_1 may determine, as valid data, the fourth remainder L4 corresponding to the fourth code block R4 that has passed the first CRC, and may store the fourth remainder LA in the internal memory 220.

The CB concatenation and TBCRC circuit 212_1 may divide a fifth target block TGB52A including the fifth code block R5 by a polynomial for the second CRC to generate a (5_1)th remainder L5_1. Thereafter, the CB concatenation and TBCRC circuit 212_1 may determine, as invalid data, the (5_1)th remainder L5_1 corresponding to the fifth code block R5 that has failed the first CRC, and may not store the (5_1)th remainder L5_1 in the internal memory 220.

The CB concatenation and TBCRC circuit 212_1 may divide a sixth target block TGB62A including the sixth code block R6 by a polynomial for the second CRC to generate a sixth remainder L6. Thereafter, the CB concatenation and TBCRC circuit 212_1 may determine, as valid data, the sixth remainder L6 corresponding to the sixth code block R6 that has passed the first CRC, and may store the sixth remainder L6 in the internal memory 220.

Referring further to FIG. 9B, the CB concatenation and TBCRC circuit 212_1 may sequentially store the valid first, third, fourth, and sixth remainders L1, L3, L4, and L6 generated during the second CRC, in the internal memory 220. For example, the first memory element CB_MEM[1] may store the first remainder L1, the third memory element CB_MEM[3] may store the third remainder L3, the fourth memory element CB_MEM[4] may store the fourth remainder LA, and the sixth memory element CB_MEM[6] may store the sixth remainder L6.

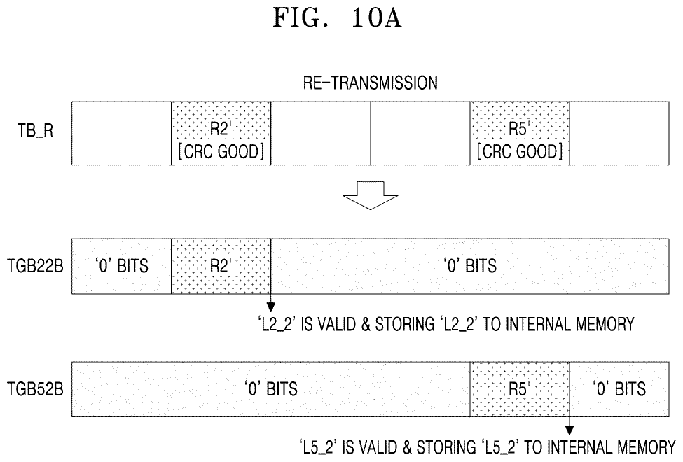

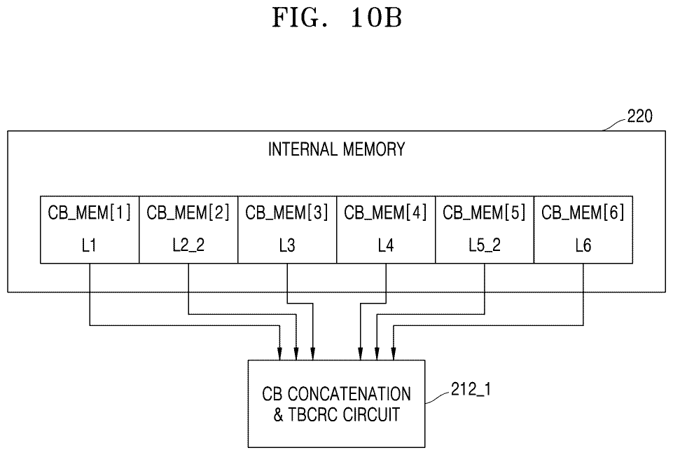

FIGS. 10A and 10B are diagrams for explaining a second CRC by a modem chip in detail, according to an embodiment. Hereinafter, to help understanding, FIG. 4 is further referred to, the contents of FIG. 9A are assumed in FIG. 10A, and the contents of FIG. 9B are assumed in FIG. 10B.

Referring to FIG. 10A, the retransmitted transmission block TB_R may include a retransmitted second code block R2′ and a retransmitted fifth code block R5′. The aforementioned HARQ retransmission of an NR network is performed in units of code block groups. However, for convenience of description, the retransmitted second code block R2′ and the retransmitted fifth code block R5′ used in the second cyclic redundancy check by the CB concatenation and TBCRC circuit 212_1 are focused on in FIG. 10A. The retransmitted second code block R2′ and the retransmitted fifth code block R5′ may be decoded in units of code blocks by the decoding and CRC circuit 211_4 and determined to be as ‘CRC GOOD’, thereby passing the first CRC.

The CB concatenation and TBCRC circuit 212_1 may divide a second target block TGB22B including the retransmitted second code block R2′ by a polynomial for the second CRC to generate a (2_2)th remainder L2_2. Thereafter, the CB concatenation and TBCRC circuit 212_1 may determine, as valid data, the (2_2)th remainder L2_2 corresponding to the retransmitted second code block R2′ that has passed the first CRC, and may store the (2_2)th remainder L2_2 in the internal memory 220.

The CB concatenation and TBCRC circuit 212_1 may divide a fifth target block TGB52B including the retransmitted fifth code block R5′ by a polynomial for the second CRC to generate a (5_2)th remainder L5_2. Thereafter, the CB concatenation and TBCRC circuit 212_1 may determine, as valid data, the (5_2)th remainder L5_2 corresponding to the retransmitted fifth code block R5′ that has passed the first CRC, and may store the (5_2)th remainder L5_2 in the internal memory 220.

Referring further to FIG. 10B, the CB concatenation and TBCRC circuit 212_1 may store the (2_2)th and (5_2)th remainders L2_2 and L5_2 in the internal memory 220. For example, the second memory element CB_MEM[2] may store the (2_2)th remainder L2_2, and the fifth memory element CB_MEM[5] may store the (5_2)th remainder L5_2.

According to an embodiment, in response to all code blocks R1, R2′, R3, R4, R5′, and R6 having passed the first CRC, the CB concatenation and TBCRC circuit 212_1 may read remainders L1, L2_2, L3, LA, L5_2, and L6 from the internal memory 220, sum up the read-out remainders L1, L2_2, L3, LA, L5_2, and L6, and determine whether the second CRC has passed, based on a result of the summation. In detail, the CB concatenation and TBCRC circuit 212_1 may generate a final remainder by dividing the result of the summation by a polynomial for the second CRC, and may determine whether the second CRC has passed or not, based on whether the final remainder is ‘0’.

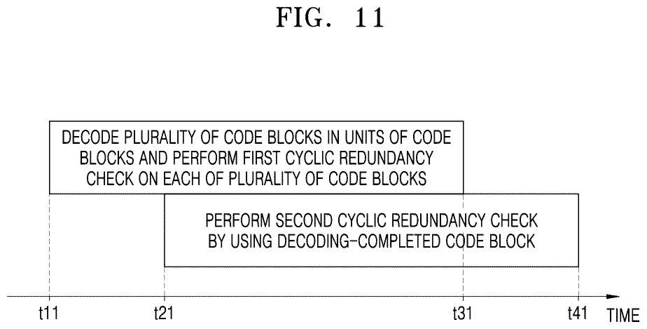

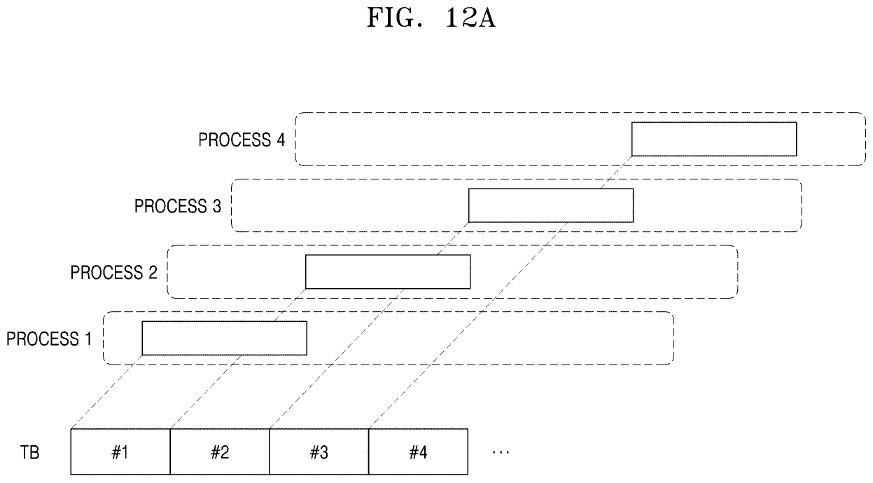

FIG. 11 is a diagram for explaining a relationship between a section in which a first CRC is performed and a section in which a second CRC is performed, according to an embodiment.

Referring to FIG. 11, a modem chip may perform code block-by-code block decoding and code block-by-code block first CRC with respect to the code blocks of a received codeword, between a first time t11 and a third time t31.

The modem chip may also perform a second CRC on a decoded transport block by using a decoding-completed code block, between a second time t21 and a fourth time t41. For example, the modem chip may partially perform the second CRC by generating a target block, based on the decoding-completed code block, and performing a modular arithmetic of dividing the target block by a polynomial for the second CRC. When there is a code block that has failed the first CRC, the modem chip may store, in an internal memory, at least one valid remainder generated in the second CRC.

As in FIG. 11, a section in which decoding of each code block and a first CRC with respect to each code block are performed by the modem chip may overlap with a section in which the second CRC is performed, between the second time t21 and the third time t31.

That is, the modem chip may partially perform the second CRC by using the decoded code blocks each time decoding of a code block is completed, without waiting for completion of the decoding and the first CRC with respect to the code blocks.

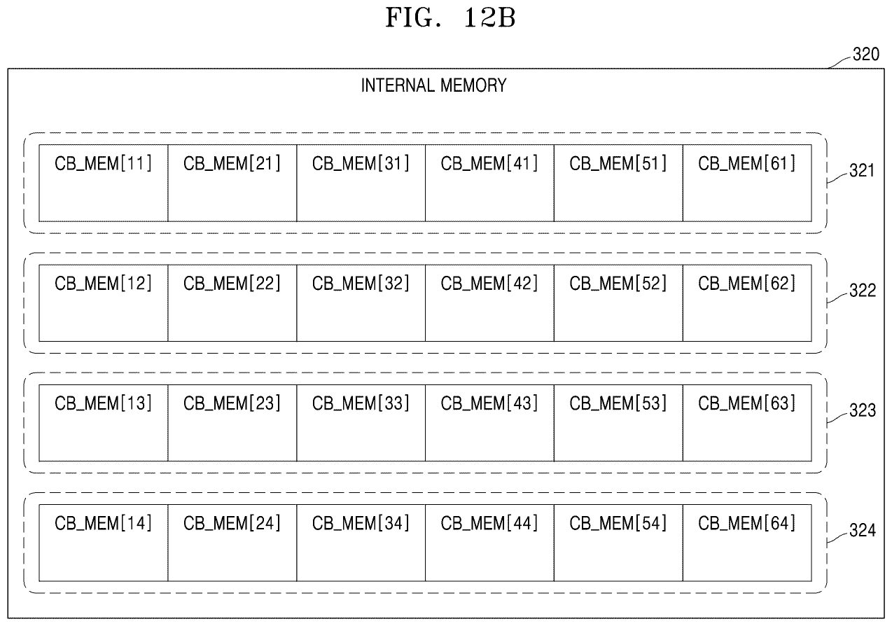

FIGS. 12A and 12B are diagrams for explaining an implementation example of an internal memory 320 according to an embodiment.

Referring to FIG. 12A, a modem chip (or a HARQ processing circuit included in the modem chip) may support a plurality of HARQ processes. For example, the modem chip may support four HARQ processes, namely, first, second, third, and fourth HARQ processes PROCESS 1, PROCESS 2, PROCESS 3, and PROCESS 4.

For example, the modem chip may perform a data processing operation with respect to first, second, third, and fourth transport blocks #1, #2, #3, and #4 received sequentially. The data processing operation may include operations for successfully decoding the first through fourth transport blocks #1 through #4. For example, the data processing operation may include decoding of each code block of the first through fourth transport blocks #1 through #4, a first CRC with respect to each code block, and a second CRC with respect to the first through fourth transport blocks #1 through #4. The technical ideas of the disclosure described above are applicable to the data processing operation.

The modem chip may perform a data processing operation with respect to the first transport block #1 through the first HARQ process PROCESS 1, may perform a data processing operation with respect to the second transport block #2 through the second HARQ process PROCESS 2, may perform a data processing operation with respect to the third transport block #3 through the third HARQ process PROCESS 3, and may perform a data processing operation with respect to the fourth transport block #4 through the fourth HARQ process PROCESS 4.

Referring further to FIG. 12B, the internal memory 320 may include first, second, third, and fourth memory areas 311, 312, 313, and 314. The first memory area 321, which is allocated to the first HARQ process PROCESS 1, may store remainders (or intermediate data) generated when the second CRC is performed on the first transport block #1 through the first HARQ process PROCESS 1. The first memory area 321 may include eleventh through sixty first memory elements CB_MEM[11] through CB_MEM[61] each allocated for each target block to classify and store remainders corresponding to target blocks generated from code blocks of the first transport block #1.

The second memory area 322, which is allocated to the second HARQ process PROCESS 2, may store remainders (or intermediate data) generated when the second CRC is performed on the second transport block #2 through the second HARQ process PROCESS 2. The second memory area 322 may include twelfth through sixty second memory elements CB_MEM[12] through CB_MEM[62] each allocated for each target block to classify and store remainders corresponding to target blocks generated from code blocks of the second transport block #2.

The third memory area 323, which is allocated to the third HARQ process PROCESS 3, may store remainders (or intermediate data) generated when the second CRC is performed on the third transport block #3 through the third HARQ process PROCESS 3. The third memory area 323 may include thirteenth through sixty third memory elements CB_MEM[13] through CB_MEM[63] each allocated for each target block to classify and store remainders corresponding to target blocks generated from code blocks of the third transport block #3.

The fourth memory area 324, which is allocated to the fourth HARQ process PROCESS 4, may store remainders (or intermediate data) generated when the second CRC is performed on the fourth transport block #4 through the fourth HARQ process PROCESS 4. The fourth memory area 324 may include fourteenth through sixty fourth memory elements CB_MEM[14] through CB_MEM[64] each allocated for each target block to classify and store remainders corresponding to target blocks generated from code blocks of the fourth transport block #4.

However, because FIGS. 12A and 12B are merely an embodiment, embodiments are not limited thereto. The modem chip may support a varying number of processes, and the internal memory 320 may be implemented appropriately for the number of supported processes.

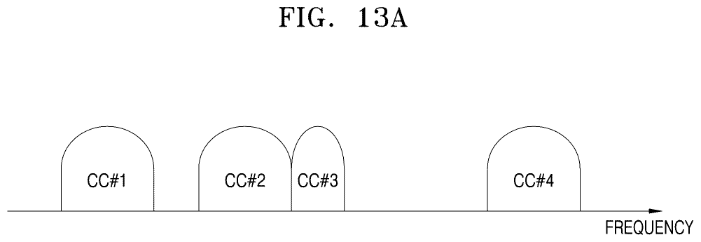

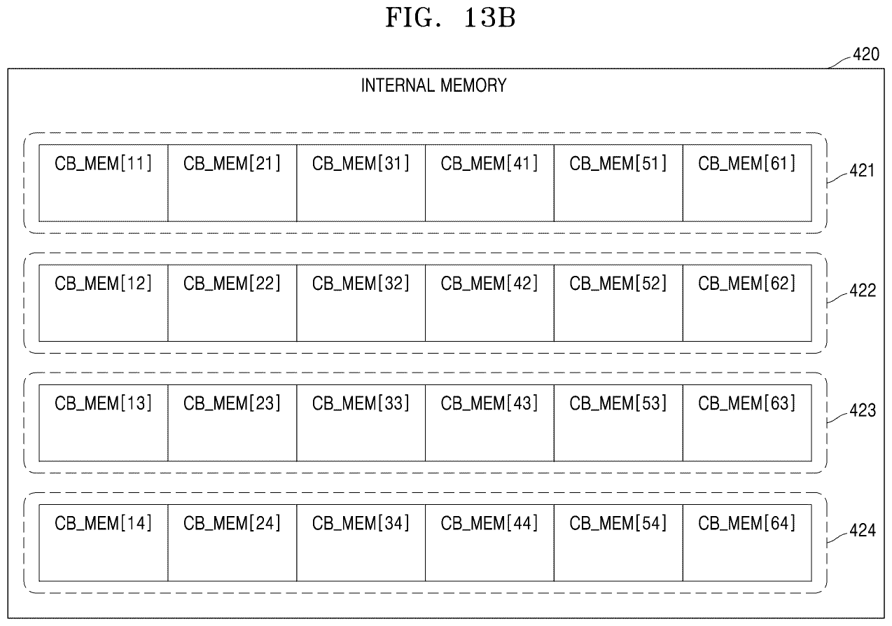

FIGS. 13A and 13B are diagrams for explaining an implementation example of an internal memory 420 according to an embodiment.

Referring to FIG. 13A, a modem chip may support communication over a plurality of component carriers. For example, the modem chip may support communication via four component carriers, namely, first, second, third, and fourth component carriers CC #1, CC #2, CC #3, and CC #4. For example, an RF chip connected to the modem chip may be set to support communication via the four component carriers, namely, the first, second, third, and fourth component carriers CC #1, CC #2, CC #3, and CC #4.

The modem chip may perform data processing operations on codewords received via the first through fourth element carriers CC #1 through CC #4.

Referring to FIG. 13B, the internal memory 420 may include first, second, third, and fourth memory areas 421, 422, 423, and 424. The first memory area 421, which is allocated to the first component carrier CC #1, may store remainders (or intermediate data) generated when the second CRC is performed on a first transport block of a first codeword received through the first component carrier CC #1. The first memory area 421 may include eleventh through sixty first memory elements CB_MEM[11] through CB_MEM[61] each allocated for each target block to classify and store remainders corresponding to target blocks generated from code blocks of the first transport block.

The second memory area 422, which is allocated to the second component carrier CC #2, may store remainders (or intermediate data) generated when the second CRC is performed on a second transport block of a second codeword received through the second component carrier CC #2. The second memory area 422 may include twelfth through sixty second memory elements CB_MEM[12] through CB_MEM[62] each allocated for each target block to classify and store remainders corresponding to target blocks generated from code blocks of the second transport block.

The third memory area 423, which is allocated to the third component carrier CC #3, may store remainders (or intermediate data) generated when the second CRC is performed on a third transport block of a third codeword received through the third component carrier CC #3. The third memory area 423 may include thirteenth through sixty third memory elements CB_MEM[13] through CB_MEM[63] each allocated for each target block to classify and store remainders corresponding to target blocks generated from code blocks of the third transport block.

The fourth memory area 424, which is allocated to the fourth component carrier CC #4, may store remainders (or intermediate data) generated when the second CRC is performed on a fourth transport block of a fourth codeword received through the fourth component carrier CC #4. The fourth memory area 424 may include fourteenth through sixty fourth memory elements CB_MEM[14] through CB_MEM[64] each allocated for each target block to classify and store remainders corresponding to target blocks generated from code blocks of the fourth transport block.

However, because FIGS. 13A and 13B are merely an embodiment, embodiments are not limited thereto. The modem chip may support communication via various numbers of component carriers, and the internal memory 420 may be implemented appropriately for the number of supported component carriers.

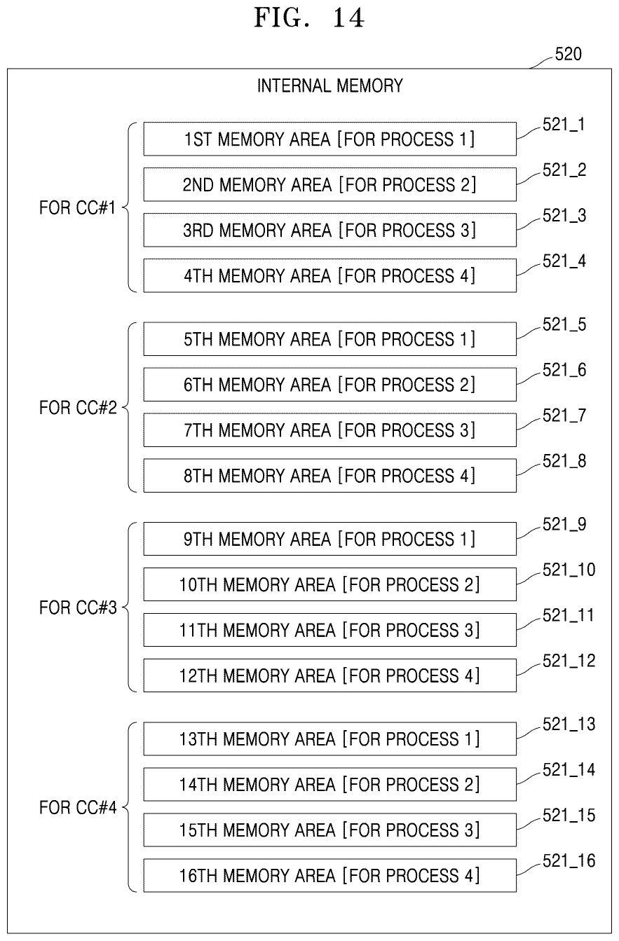

FIG. 14 is a block diagram for explaining an implementation example of an internal memory 520 according to an embodiment.

Referring to FIG. 14, the internal memory 520 may include first, second, third, fourth, fifth, sixth, seventh, eighth, ninth, tenth, eleventh, twelfth, thirteenth, fourteenth, fifteenth, and sixteenth memory areas 521_1, 521_2, 521_3, 521_4, 521_5, 521_6, 521_7, 521_8, 521_9, 521_10, 521_11, 521_12, 521_13, 521_14, 521_15, and 521_16.

According to an embodiment, the first through fourth memory areas 521_1 through 521_4, which are allocated to the first component carrier CC #1, may store first remainders (or first intermediate data) generated when the second CRC is performed on transport blocks of codewords received through the first component carrier CC #1. The first memory area 521_1 may be allocated to the first HARQ process PROCESS 1, and may store a portion of the first remainders (or the first intermediate data) that is generated through the first HARQ process PROCESS 1. The second memory area 521_2 may be allocated to the second HARQ process PROCESS 2, and may store a portion of the first remainders (or the first intermediate data) that is generated through the second HARQ process PROCESS 2. The third memory area 521_3 may be allocated to the third HARQ process PROCESS 3, and may store a portion of the first remainders (or the first intermediate data) that is generated through the third HARQ process PROCESS 3. The fourth memory area 521_4 may be allocated to the fourth HARQ process PROCESS 4, and may store a portion of the first remainders (or the first intermediate data) that is generated through the fourth HARQ process PROCESS 4.

According to an embodiment, the fifth through eighth memory areas 521_5 through 521_8, which are allocated to the second component carrier CC #2, may store second remainders (or second intermediate data) generated when the second CRC is performed on transport blocks of codewords received through the second component carrier CC #2. The fifth memory area 521_5 may be allocated to the first HARQ process PROCESS 1, and may store a portion of the second remainders (or the second intermediate data) that is generated through the first HARQ process PROCESS 1. The sixth memory area 521_6 may be allocated to the second HARQ process PROCESS 2, and may store a portion of the second remainders (or the second intermediate data) that is generated through the second HARQ process PROCESS 2. The seventh memory area 521_7 may be allocated to the third HARQ process PROCESS 3, and may store a portion of the second remainders (or the second intermediate data) that is generated through the third HARQ process PROCESS 3. The eighth memory area 521_8 may be allocated to the fourth HARQ process PROCESS 4, and may store a portion of the second remainders (or the second intermediate data) that is generated through the fourth HARQ process PROCESS 4.

According to an embodiment, the ninth through twelfth memory areas 521_9 through 521_12, which are allocated to the third component carrier CC #3, may store third remainders (or third intermediate data) generated when the second CRC is performed on transport blocks of codewords received through the third component carrier CC #3. The ninth memory area 521_9 may be allocated to the first HARQ process PROCESS 1, and may store a portion of the third remainders (or the third intermediate data) that is generated through the first HARQ process PROCESS 1. The tenth memory area 521_10 may be allocated to the second HARQ process PROCESS 2, and may store a portion of the third remainders (or the third intermediate data) that is generated through the second HARQ process PROCESS 2. The eleventh memory area 521_11 may be allocated to the third HARQ process PROCESS 3, and may store a portion of the third remainders (or the third intermediate data) that is generated through the third HARQ process PROCESS 3. The twelfth memory area 521_12 may be allocated to the fourth HARQ process PROCESS 4, and may store a portion of the third remainders (or the third intermediate data) that is generated through the fourth HARQ process PROCESS 4.

According to an embodiment, the thirteenth through sixteenth memory areas 521_13 through 521_16, which are allocated to the fourth component carrier CC #4, may store fourth remainders (or fourth intermediate data) generated when the second CRC is performed on transport blocks of codewords received through the fourth component carrier CC #4. The thirteenth memory area 521_13 may be allocated to the first HARQ process PROCESS 1, and may store a portion of the fourth remainders (or the fourth intermediate data) that is generated through the first HARQ process PROCESS 1. The fourteenth memory area 521_14 may be allocated to the second HARQ process PROCESS 2, and may store a portion of the fourth remainders (or the fourth intermediate data) that is generated through the second HARQ process PROCESS 2. The fifteenth memory area 521_15 may be allocated to the third HARQ process PROCESS 3, and may store a portion of the fourth remainders (or the fourth intermediate data) that is generated through the third HARQ process PROCESS 3. The sixteenth memory area 521_16 may be allocated to the fourth HARQ process PROCESS 4, and may store a portion of the fourth remainders (or the fourth intermediate data) that is generated through the fourth HARQ process PROCESS 4.

However, because FIG. 14 is merely an embodiment, embodiments are not limited thereto. The modem chip may support various numbers of processes and various numbers of component carriers, and the internal memory 520 may be implemented appropriately for the number of supported processes and the number of supported component carriers.

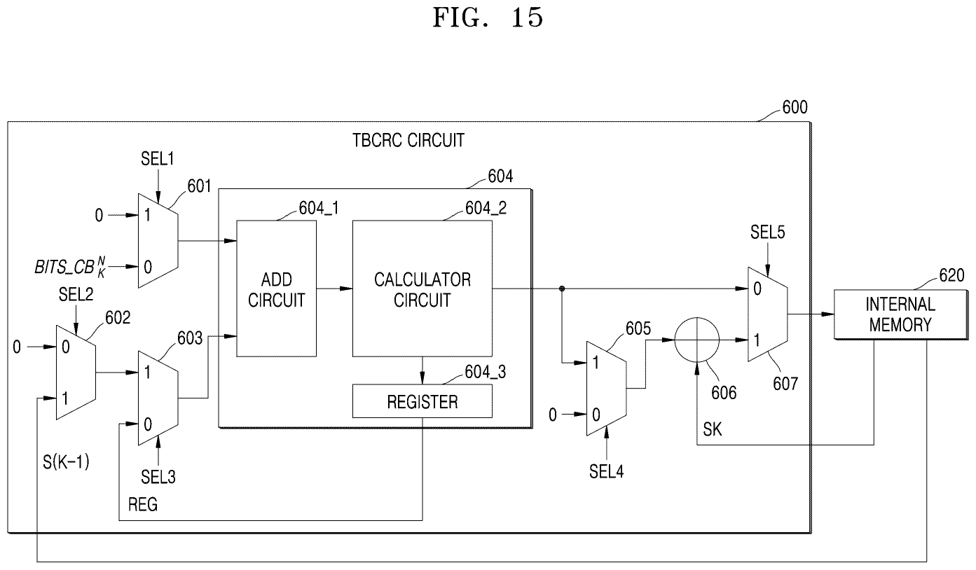

FIG. 15 is a block diagram of a CB concatenation and TBCRC circuit 600 according to an embodiment.

Referring to FIG. 15, the CB concatenation and TBCRC circuit 600 may include first, second, third, fourth, and fifth multiplexers 601, 602, 603, 605, and 607, a TBCRC circuit 604, and an adder 606. The TBCRC circuit 604, which is a circuit that performs a second CRC, may include an add circuit 604_1, a calculation circuit 604_2, and a register 604_3.

$$C {B}_{K}^{N}$$

may be an input indicating whether a K-th (where K is an integer greater than or equal to 1) code block of an N-th (where N is an integer greater than or equal to 1) transmitted codeword has passed the first CRC after bring decoded. For example, when

$$C {B}_{K}^{N}$$

is ‘1’, it may indicate that the first CRC has passed, and, when

$$C {B}_{K}^{N}$$

is ‘0’, it may indicate that the first CNC has failed. Because, when

$$C {B}_{K}^{N - 1}$$

is ‘1’, it may indicate that an K-th code block of an (N−1)th transmitted codeword has passed the first CRC,

$$C {B}_{K}^{N - 1}$$

may be ‘1’. An arithmetic operation for obtaining the remainder of a target block corresponding to the K-th code block of the N-th transmitted codeword may be based on

$$C {B}_{K}^{N - 1}$$

corresponding to the K-th code block of the (N−1)th transmitted codeword,

$$C {B}_{K + 1}^{N - 1}$$

corresponding to a (A+1) in code block of the (N−1)th transmitted codeword,

$$C {B}_{K - 1}^{N}$$

corresponding to a (N−1) in code block of the N-th transmitted codeword, and

$$C {B}_{K}^{N}$$

corresponding to the K-th code block of the N-th transmitted codeword.

The first multiplexer 601 may output either

$${BITS\_CB}_{K}^{N}$$

or ‘0’ received based on a first selection signal SEL1 corresponding to

$$C {B}_{K}^{N - 1}$$

to the add circuit

$$604 \_ 1. {BITS\_CB}_{K}^{N}$$

may indicate decoded bits included in the K-th code block of the N-th transmitted codeword.

The second multiplexer 602 may output either ‘S(K−1)’ or ‘0’ received based on a second selection signal SEL2 corresponding to

$$C {B}_{K - 1}^{N}$$

to the third multiplexer 603. ‘S(K−1)’ may indicate a remainder corresponding to the (K−1)th code block of the N-th transmitted codeword.

The third multiplexer 603 may output one of an output of the third multiplexer 602 and a register value REG both received based on a third selection signal SEL3 corresponding to

$$C {B}_{K}^{N - 1}$$

to the add circuit 604_1.

The add circuit 604_1 may add an output of the third multiplexer 603 to the output of the first multiplexer 601. For example, when the output of the first multiplexer 601 is ‘111111’, the add circuit 604_1 may add ‘010’, which is the output of the second multiplexer 602, to the front of ‘111111’ to generate ‘010111111’. The add circuit 604_1 may further add zero bits to the output of the first multiplexer 601. That is, the add circuit 604_1 may generate a target block corresponding to the K-th code block of the N-th transmitted codeword.

The calculation circuit 604_2 may perform a modular arithmetic on the target block provided by the add circuit 604_1. The calculation circuit 604_2 may store a remainder corresponding to the target block, which is a result of the modular arithmetic, in the register 604_3, or may output the same as inputs of the fourth and fifth multiplexers 605 and 607.

The fourth multiplexer 605 may output either the result of the modular arithmetic provided by the calculation circuit 604_2 or ‘0’ to the adder 606, based on a fourth selection signal SELA. For example, a value of the fourth selection signal SEL4 may be set based on whether an update of the remainder corresponding to the K-th code block is needed.

The adder 606 may add the output of the fourth multiplexer 605 to ‘SK’ and output a result of the addition. ‘SK’ may indicate a remainder corresponding to the K-th code block of the N-th transmitted codeword.

The fifth multiplexer 607 may store, in the internal memory 620, either the result of the modular arithmetic provided by the calculation circuit 604_2 or the output of the adder 606, based on a fifth selection signal SEL5. For example, a value of the fifth selection signal SEL5 may be set based on whether decoding of the K-th and (K−1)th code blocks of the (N−1)th transmitted codeword has been succeeded.

However, FIG. 15 is merely an exemplary embodiment, and thus embodiments are not limited thereto. Various CB concatenation and TBCRC circuits 600 may be implemented so as to perform a second CRC according to the embodiments.

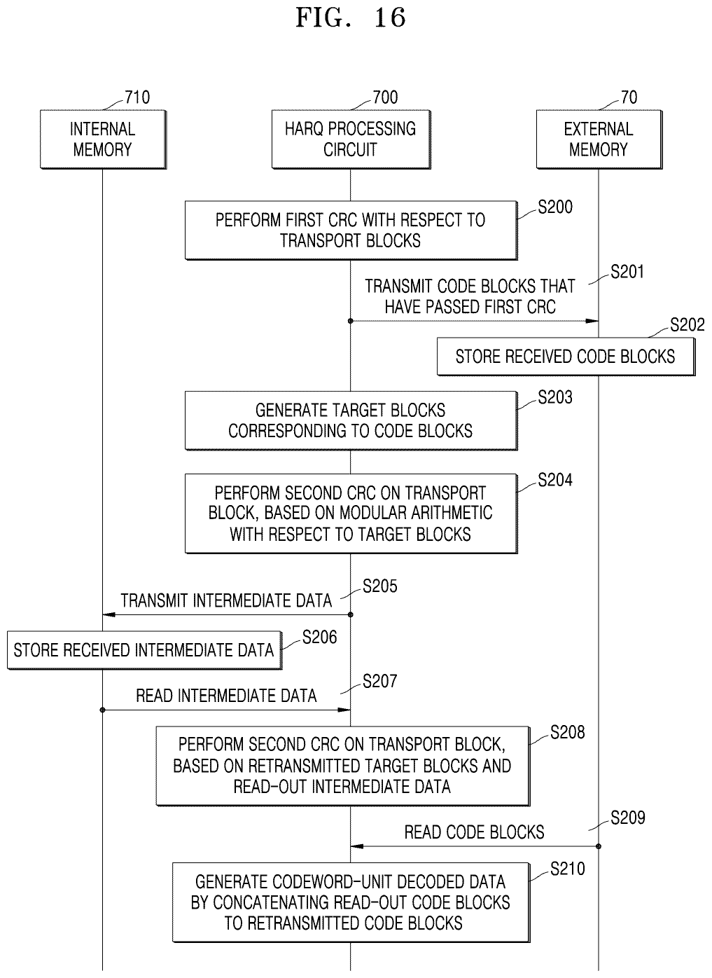

FIG. 16 is a flowchart of an operation method of an HARQ processing circuit 710 according to an embodiment. The HARQ processing circuit 710 is a component included in a modem chip, together with an internal memory 720, and an operation of the HARQ processing circuit 710 may be understood as an operation of the modem chip. In FIG. 16, it is assumed that both code blocks and a transport block are in a decoded state and there are code blocks that need retransmission among the code blocks.

Referring to FIG. 16, in operation S200, the HARQ processing circuit 710 may perform a first CRC with respect to the transport blocks.

In operation S201, the HARQ processing circuit 710 may transmit, to an external memory 70, code blocks that have passed the first CRC.

In operation S202, the external memory 70 may store the code blocks received from the HARQ processing circuit 710.

In operation S203, the HARQ processing circuit 710 may generate target blocks corresponding to the code blocks.

In operation S204, the HARQ processing circuit 710 may perform a second CRC on the transport block, based on a modular arithmetic with respect to the target blocks.

In operation S205, the HARQ processing circuit 710 may transmit intermediate data of the second CRC to the internal memory 720.

In operation S206, the internal memory 720 may store the received intermediate data.

In operation S207, the HARQ processing circuit 710 may read the intermediate data from the internal memory 720.

In operation S208, the HARQ processing circuit 710 may perform a second CRC on the transport block, based on the retransmitted target blocks that have passed the first CRC and the read-out intermediate data.

In operation S209, the HARQ processing circuit 710 may read code blocks from the external memory 70, when the second CRC has passed.

In operation S210, the HARQ processing circuit 710 may generate codeword-unit decoded data by concatenating the read-out code blocks to the retransmitted code blocks.

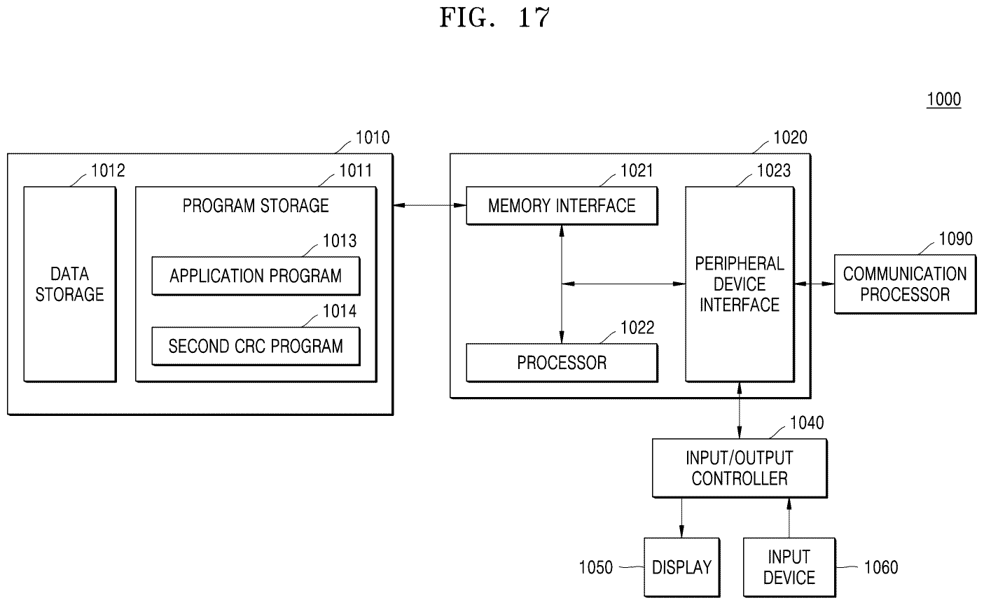

FIG. 17 is a block diagram of an electronic device 1000 according to an embodiment.

Referring to FIG. 17, the electronic device 1000 may include a memory 1010, a processor unit 1020, an input/output controller 1040, a display 1050, an input device 1060, and a communication processor 1090. There may be a plurality of memories 1010. Each element will be described below.

The memory 1010 may include a program storage 1011, which stores a program for controlling an operation of the electronic device 1000, and a data storage 1012, which stores data generated during execution of the program. The data storage 1012 may store data necessary for respective operations of an application program 1013 and a second CRC program 1014.

The program storage 1011 may include the application program 1013 and the second CRC program 1014. A program included in the program storage 1011 is a set of instructions, and may be expressed as an instruction set. The application program 1013 may include program code for executing various applications run by the electronic device 1000. In other words, the application program 1013 may include code (or commands) related to various applications run by a processor 1022. The second CRC program 1014 may include control codes for performing a second CRC on a transport block, based on target blocks according to embodiments.

According to an embodiment, the processor 1022 may execute the second CRC program 1014 to sequentially generate target blocks from the code and perform a second CRC on a transport block, based on a modular arithmetic with respect to the target blocks. The processor 1022 may include an internal memory, and may store intermediate data generated during the second cyclic redundancy check in the internal memory.

The communication processor 1090 of the electronic device 1000 may perform communication functions for voice communication and data communication.

A peripheral device interface 1023 may control connection among the input/output controller 1040, the communication processor 1090, the processor 1022, and a memory interface 1021. The processor 1022 controls a plurality of cells to provide a service by using at least one software program. At this time, the processor 1022 may execute at least one program stored in the memory 1010 to provide a service corresponding to the program.

The input/output controller 1040 may provide an interface between an input/output device, such as the display 1050 or the input device 1060, and the peripheral device interface 1023. The display 1050 displays status information, input text, a moving picture, and a still picture, for example. For example, the display 1050 may display information about an application program run by the processor 1022.

The input device 1060 may provide input data, which is generated by the selection of the electronic device 1000, to the processor unit 1020 through the input/output controller 1040. In this case, the input device 1060 may include, for example, a keypad, which includes at least one hardware button, and a touch pad sensing touch information. For example, the input device 1060 may provide touch information, such as a touch, a movement of the touch, or the release of the touch, which is detected through a touch pad, to the processor 1022 through the input/output controller 1040.

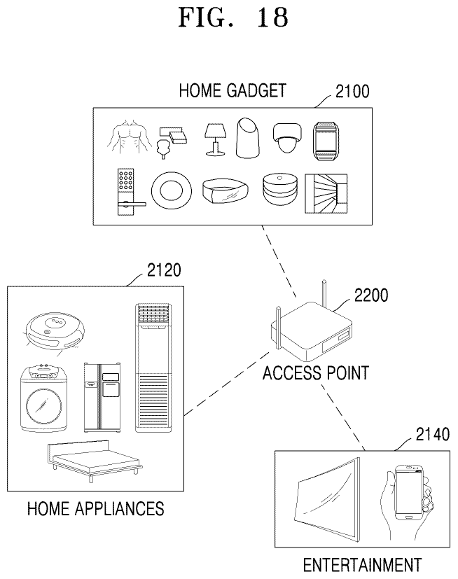

FIG. 18 is a view illustrating communication apparatuses configured to perform a second CRC according to an embodiment.

Referring to FIG. 18, a modem included in a home gadget 2100, home appliances 2120, an entertainment device 2140, and an access point (AP) 2200 may perform a second CRC according to embodiments. The modem may utilize its internal memory when performing a second CRC.

According to embodiments, the home gadget 2100, the home appliances 2120, the entertainment device 2140, and the AP 2200 may constitute an Internet of Things (IoT) network system. The communication devices illustrated in FIG. 18 are merely examples, and it will be understood that that other communication devices not illustrated in FIG. 18 may also include a wireless communication device according to an embodiment.

Various changes in form and details may be made to the embodiments provided without departing from the spirit and scope of the following claims.

1. A modem chip configured to receive a codeword including a transport block including a plurality of code blocks, the modem chip comprising:
a hybrid automatic repeat request (HARQ) processing circuit configured to perform a HARQ-based processing operation with respect to the codeword; and
an internal memory configured to store data generated by the HARQ processing circuit,
wherein the HARQ processing circuit comprises:
a code block processing circuit configured to:
decode the plurality of code blocks in units of code blocks to obtain a plurality of decoded code blocks, and
perform a first cyclic redundancy check on each decoded code block of the plurality of decoded code blocks; and
a codeword processing circuit configured to perform a second cyclic redundancy check on a decoded transport block, and
wherein the second cyclic redundancy check comprises:
a first operation of sequentially generating, based on a modular arithmetic using a polynomial for the second cyclic redundancy check, target blocks corresponding to decoded code blocks, and
a second operation of determining, based on a final remainder corresponding to a last target block among the target blocks, whether the second cyclic redundancy check has passed.

2. The modem chip of claim 1, wherein the codeword processing circuit is further configured to, based on passing the first cyclic redundancy check and the second cyclic redundancy check, concatenate the decoded code blocks to generate the decoded transport block.

3. The modem chip of claim 1, wherein the code block processing circuit is further configured to store, in an external memory, a decoded second code block that passed the first cyclic redundancy check from among the decoded code blocks, based on a decoded first code block among the decoded code blocks that failed the first cyclic redundancy check.

4. The modem chip of claim 3, wherein the HARQ processing circuit is further configured to be connected to the external memory through a bus.

5. The modem chip of claim 4, wherein the internal memory is dedicated to the modem chip, and
wherein the external memory is configured to be shared with an external device.

6. (canceled)

7. The modem chip of claim 1, wherein a first section of the codeword in which the first cyclic redundancy check is performed by the code block processing circuit partially overlaps with a second section of the codeword in which the second cyclic redundancy check is performed by the codeword processing circuit.

8. The modem chip of claim 1, wherein the codeword processing circuit is further configured to store, in the internal memory, at least one valid remainder from among remainders corresponding to the target blocks.

9. The modem chip of claim 8, wherein the codeword processing circuit is further configured to:
based on a retransmitted first code block being decoded and passing the first cyclic redundancy check in the code block processing circuit, read the at least one valid remainder from the internal memory, and
update the final remainder based on a target block corresponding to the retransmitted first code block and the at least one valid remainder.

10. The modem chip of claim 1, wherein the decoded code blocks comprise a first code block, a second code block, and a third code block sequentially processed by the code block processing circuit, and
wherein the target blocks comprise:
a first target block comprising the first code block and zero bits,
a second target block comprising the second code block, zero bits, and a first remainder obtained by dividing the first target block by the polynomial, and
a third target block comprising the third code block, zero bits, and a second remainder obtained by dividing the second target block by the polynomial.

11. The modem chip of claim 10, wherein the codeword processing circuit is further configured to, based on the first code block and the second code block having passed the first cyclic redundancy check and the third code block having failed the first cyclic redundancy check, store the second remainder in the internal memory.

12. The modem chip of claim 1, wherein the codeword processing circuit is further configured to, based on the decoded code blocks having all passed the first cyclic redundancy check, perform the second operation of determining whether the second cyclic redundancy check has passed.

13. The modem chip of claim 1, wherein the internal memory comprises memory elements each allocated for each target block to classify and store remainders corresponding to the target blocks.

14. The modem chip of claim 1, wherein the HARQ processing circuit is further configured to support a plurality of HARQ processes,
wherein the internal memory comprises a plurality of memory areas allocated to the plurality of HARQ processes, and
wherein a memory area corresponding to an HARQ process of the transport block among the plurality of memory areas comprises memory elements allocated for the target blocks, respectively, to classify and store remainders corresponding to the target blocks.

15. The modem chip of claim 1, wherein the transport block is transmitted via a first component carrier from among a plurality of component carriers,
wherein the internal memory comprises a plurality of memory areas allocated to the plurality of component carriers, respectively, and
wherein a memory area corresponding to the first component carrier among the plurality of memory areas comprises memory elements allocated for the target blocks, respectively, to classify and store remainders corresponding to the target blocks.

16. A modem chip configured to communication with an external memory via a bus, the modem chip comprising:
a hybrid automatic repeat request (HARQ) processing circuit configured to perform a HARQ-based processing operation with respect to a codeword comprising a transport block composed of a plurality of code blocks; and
an internal memory configured to assist an operation of the HARQ processing circuit,
wherein the HARQ processing circuit comprises:
a code block processing circuit configured to store, in the external memory, decoded second code blocks, excluding a decoded first code block that has failed a first cyclic redundancy check, among the decoded code blocks; and
a codeword processing circuit configured to store intermediate data generated from a second cyclic redundancy check in the internal memory, based on the second cyclic redundancy check being temporarily suspended due to a failure of the decoded first code block in the first cyclic redundancy check, while performing a second cyclic redundancy check on a decoded transport block based on target blocks corresponding to the decoded code blocks.

17. The modem chip of claim 16, wherein a size of the intermediate data is based on a polynomial used in a modular arithmetic during the second cyclic redundancy check.

18. The modem chip of claim 16, wherein the code block processing circuit is further configured to perform decoding and the first cyclic redundancy check with respect to a retransmitted first code block, and
the codeword processing circuit is further configured to read the intermediate data from the internal memory based on the decoding of the retransmitted first code block having passed the first cyclic redundancy check, and to resume the second cyclic redundancy check based on the intermediate data and a target block corresponding to the decoded first code block.

19. The modem chip of claim 18, wherein the codeword processing circuit is further configured to, based on the second cyclic redundancy check having passed, read the decoded second code blocks from the external memory and concatenate the decoded second code blocks with the decoded first code block to generate the decoded transport block.

20. The modem chip of claim 16, wherein the second cyclic redundancy check comprises:
a first operation of sequentially generating the target blocks based on a modular arithmetic using a polynomial for the second cyclic redundancy check; and
a second operation of determining whether the second cyclic redundancy check has passed, based on a final remainder corresponding to a last target block among the target blocks.

21. (canceled)

22. A system on chip comprising:
a modem comprising an internal memory, the modem configured to support a hybrid automatic repeat request (HARQ) function;
a processor configured to perform a certain data processing operation; and
a memory configured to be shared by the modem and by the processor,
wherein the modem is further configured to:
store, in the memory, a decoded first code block that passed a first cyclic redundancy check among the decoded code blocks, and
store, in the internal memory, intermediate data generated during a second cyclic redundancy check with respect to a transport block corresponding to the decoded code blocks.

23.-28. (canceled)
